(19) United States
(12) Patent Application Publication
(10) Pub. No.: US 2022/0296449 A1
(43) Pub. Date: Sep. 22, 2022

(54) TREATMENT DEVICE ASSEMBLY INCLUDING HEADREST ASSEMBLY WITH INTEGRATED FILTER ASSEMBLY

(71) Applicant: Earthlite, LLC, Vista, CA (US)

(72) Inventors: William Martin, Carlsbad, CA (US); Richard V. Estrada, Oceanside, CA (US); James Chenevey, Encinitas, CA (US)

(21) Appl. No.: 17/699,635

(22) Filed: Mar. 21, 2022

Related U.S. Application Data
(63) Continuation of application No. 63/163,579, filed on Mar. 19, 2021.

(51) Int. Cl. A61G 13/12; A61G 13/00; B01D 39/08

(52) U.S. Cl. CPC A61G 13/121; A61G 13/009; B01D 39/083; A61H 2201/0138; B01D 2201/31

(57) ABSTRACT

A headrest assembly for supporting a head or face of a user of a treatment device includes a headrest and a filter assembly. The headrest is configured to support the head or face of the user. The filter assembly is coupled to the headrest. The filter assembly includes a filter connector that is selectively coupled to the headrest, and a filter body that extends in a generally downward direction away from the filter connector. The filter body can extend in a generally downward direction away from an inner edge or an outer edge of the filter connector. The filter body includes sides and a base that cooperate to define at least a portion of a filtering cavity that is configured to be positioned substantially directly below the head or face of the user when the head or face of the user is supported by the headrest.

### RELATED APPLICATION

This application claims priority on U.S. Provisional Application Ser. No. 63/163,579, filed on Mar. 19, 2021, and entitled “TREATMENT DEVICE ASSEMBLY INCLUDING HEADREST ASSEMBLY WITH INTEGRATED FILTER ASSEMBLY”. As far as permitted, the contents of U.S. Provisional Application Ser. No. 63/163,579 are incorporated in their entirety herein by reference.

### BACKGROUND

As the benefits of therapeutic treatments such as therapeutic massage and/or other comparable therapeutic treatments are becoming more widely appreciated, more and more people are participating in such therapeutic treatments. A typical treatment table designed for use during therapeutic massage or other comparable therapeutic treatments allows the patient to be lying down while receiving a massage or other treatment. A typical treatment chair allows the patient to be sitting while receiving a massage or other therapeutic treatment. Both types of therapeutic treatment devices can include a headrest that supports the head of the patient during the massage or other therapeutic treatment.

Additionally, during the current coronavirus pandemic, many people desire to ensure that they are adequately protecting themselves and others from potential infection from the coronavirus, and they do so by consistently wearing masks over their mouth and nose when around other people. However, it is not necessarily comfortable or convenient for people to wear a mask while they are receiving therapeutic treatments. Thus, it is desired to provide a means to ensure that patients are able to adequately protect themselves and others from potential infection from the coronavirus while receiving any such therapeutic treatments without the necessity of wearing a mask.

### SUMMARY

The present invention is directed toward a headrest assembly for supporting a head or face of a user of a treatment device. In various embodiments, the headrest assembly includes a headrest and a filter assembly. The headrest is configured to support the head or face of the user. The filter assembly is coupled to the headrest.

In some embodiments, the filter assembly includes a filter connector that is selectively coupled to the headrest. Additionally, the filter assembly can further include a filter body that extends in a generally downward direction away from the filter connector. In one embodiment, the filter body is integrally formed with the filter connector. Alternatively, in another embodiment, the filter body is coupled to the filter connector.

In some embodiments, the filter connector includes an inner edge, and the filter body extends in a generally downward direction away from the inner edge of the filter connector. Alternatively, in other embodiments, the filter connector includes an outer edge, and the filter body extends in a generally downward direction away from the outer edge of the filter connector.

In some embodiments, the filter connector includes an elastic strap.

In certain embodiments, the filter body includes sides and a base that cooperate to define at least a portion of a filtering cavity that is configured to be positioned substantially directly below the head or face of the user when the head or face of the user is supported by the headrest. Additionally, in some embodiments, the filter body is formed from a fabric material. For example, in certain such embodiments, the filter body is formed from at least one of a cotton material and a microfiber material.

In some embodiments, the headrest includes a headrest cushion and a headrest platform that is configured to support the headrest cushion.

In certain embodiments, the filter assembly includes a filter connector that is coupled to an upper surface of the headrest platform. In such embodiments, the filter connector can be coupled to the upper surface of the headrest platform with a coupling assembly, the coupling assembly including one or more first coupling members that are secured to the upper surface of the headrest platform, and one or more second coupling members that are secured to a lower surface of the filter connector, each of the one or more second coupling members being configured to engage one of the one or more first coupling members. Additionally, in one embodiment, the one or more first coupling members and the one or more second coupling members of the coupling assembly include hook-and-loop material.

The filter connector can be positioned substantially between the headrest platform and the headrest cushion. In one such embodiment, the headrest further includes a second coupling assembly that is configured to couple an upper surface of the filter connector to a lower surface of the headrest cushion, the second coupling assembly including one or more first coupling members that are secured to the lower surface of the headrest cushion, and one or more second coupling members that are secured to the upper surface of the filter connector, each of the one or more second coupling members being configured to engage one of the one or more first coupling members. Additionally, in such embodiment, the one or more first coupling members and the one or more second coupling members of the second coupling assembly can include hook-and-loop material.

In one embodiment, the filter assembly includes a filter connector that is coupled to an upper surface of the headrest cushion.

The present invention is also directed toward a treatment device assembly including a treatment device that supports the user during a therapeutic treatment, and the headrest assembly as described above that is selectively coupled to the treatment device.

Additionally, the present invention is further directed toward a method for supporting a head of a user of a treatment device, the method including the steps of supporting the head or face of the user with a headrest; and coupling a filter assembly to the headrest.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified perspective view of a user and a portion of an embodiment of a treatment device assembly having features of the present invention, the treatment device assembly including a headrest assembly having a filter assembly incorporated therein;

FIG. 2A is a simplified perspective view of a portion of an embodiment of the headrest assembly including an embodiment of the filter assembly;

FIG. 2B is a partially exploded view of the portion of the headrest assembly illustrated in FIG. 2A;

FIG. 3A is a simplified top perspective view of the filter assembly illustrated in FIG. 2A;

FIG. 3B is a simplified bottom perspective view of the filter assembly illustrated in FIG. 3A;

FIG. 3C is a simplified top view of the filter assembly illustrated in FIG. 3A;

FIG. 3D is a simplified front view of the filter assembly illustrated in FIG. 3A;

FIG. 3E is a simplified side view of the filter assembly illustrated in FIG. 3A;

FIG. 4 is a simplified perspective view of a user and a portion of another embodiment of the treatment device assembly including a headrest assembly having another embodiment of the filter assembly incorporated therein;

FIG. 5A is a simplified perspective view of the headrest assembly including the embodiment of the filter assembly illustrated in FIG. 4;

FIG. 5B is a partially exploded view of the headrest assembly illustrated in FIG. 5A;

FIG. 6A is a simplified perspective view of the filter assembly illustrated in FIG. 5A;

FIG. 6B is a simplified top view of the filter assembly illustrated in FIG. 6A;

FIG. 6C is a simplified front view of the filter assembly illustrated in FIG. 6A;

FIG. 6D is a simplified side view of the filter assembly illustrated in FIG. 6A;

FIG. 7 is a simplified perspective view of a user and a portion of still another embodiment of the treatment device assembly including a headrest assembly having still another embodiment of the filter assembly incorporated therein;

FIG. 8 is a partially exploded view of the headrest assembly including the embodiment of the filter assembly illustrated in FIG. 7;

FIG. 9A is a simplified perspective view of the filter assembly illustrated in FIG. 8;

FIG. 9B is a simplified top view of the filter assembly illustrated in FIG. 9A;

FIG. 9C is a simplified front view of the filter assembly illustrated in FIG. 9A;

FIG. 9D is a simplified side view of the filter assembly illustrated in FIG. 9A;

FIG. 10 is a simplified perspective view of a user and a portion of yet another embodiment of the treatment device assembly including a headrest assembly having still another embodiment of the filter assembly incorporated therein;

FIG. 11A is a simplified perspective view of the headrest assembly including the embodiment of the filter assembly illustrated in FIG. 10;

FIG. 11B is a partially exploded view of the headrest assembly illustrated in FIG. 11A,

FIG. 12A is a simplified top perspective view of the filter assembly illustrated in FIG. 11A,

FIG. 12B is a simplified bottom perspective view of the filter assembly illustrated in FIG. 12A;

FIG. 12C is a simplified top view of the filter assembly illustrated in FIG. 12A;

FIG. 12D is a simplified front view of the filter assembly illustrated in FIG. 12A;

FIG. 12E is a simplified side view of the filter assembly illustrated in FIG. 12A;

FIG. 13 is a simplified perspective view of a portion of still yet another embodiment of the treatment device assembly including a headrest assembly having still yet another embodiment of the filter assembly incorporated therein;

FIG. 14A is a simplified top perspective view of the filter assembly illustrated in FIG. 13; and

FIG. 14B is a partially exploded perspective view of the filter assembly illustrated in FIG. 14A.

### DESCRIPTION

Embodiments of the present invention are described herein in the context of a treatment device assembly including a treatment device that is configured to support a user above a surface while receiving a therapeutic treatment, and a headrest assembly that is coupled to the treatment device. The headrest assembly is configured to support a head of the user while receiving the therapeutic treatment. Importantly, the headrest assembly includes a headrest and a filter assembly that is coupled to the headrest. In particular, the filter assembly is uniquely configured to provide a physical (filtered) barrier between a face of the user and a treatment provider to trap respiratory particulates and to inhibit and/or filter the dispersal or spread of respiratory droplets and potentially viral respiratory aerosols between the user and the treatment provider so that the user does not need to wear a mask while receiving the therapeutic treatment. Additionally, as provided herein, the filter assembly can be formed from one or more materials that allow for the easy exchange of fresh oxygenated air.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

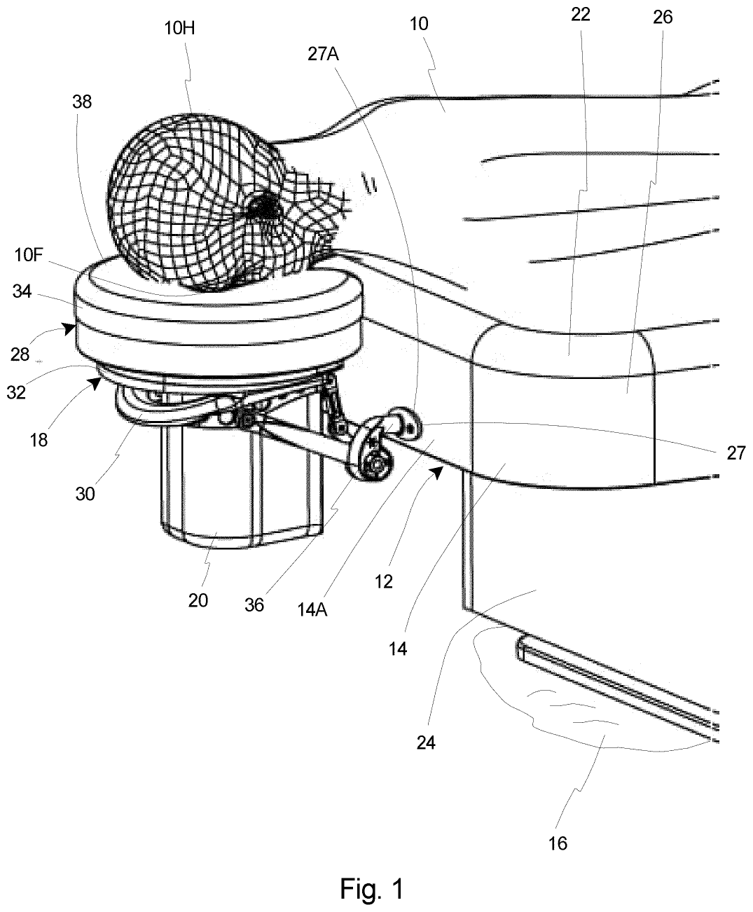

FIG. 1 is a simplified perspective view of a user 10, i.e. a therapeutic treatment recipient, and a portion of an embodiment of a treatment device assembly 12 having features of the present invention. The design of the treatment device assembly 12 can be varied. As illustrated in the embodiment shown in FIG. 1, the treatment device assembly 12 includes (i) a treatment device 14 that is configured to support the user 10 of the treatment device assembly 12 above a surface 16, and (ii) a headrest assembly 18 that is coupled to the treatment device 14, e.g., to an end 14A of the treatment device 14. Additionally, as shown, the headrest assembly 18 includes a filter assembly 20 that is integrated and/or incorporated within the headrest assembly 18. Alternatively, the treatment device assembly 12 can include more components than those specifically illustrated in FIG. 1.

As provided herein, the treatment device 14 is configured to support the user 10 above the surface 16 as the user 10 is receiving a massage or other therapeutic treatment. The design of the treatment device 14 can be varied to suit the needs of the user 10. In certain embodiments, as shown, the treatment device 14 can include a device body 22 and a device support assembly 24 that supports the device body 22 above and/or relative to the surface 16.

As illustrated in FIG. 1, the treatment device 14 is shown as a treatment table that supports the user 10, with the user 10 lying down, e.g., in the prone position, for purposes of receiving a therapeutic treatment. However, it is appreciated that the treatment device 14 can have another suitable design, and does not have to be provided in the form of a treatment table. For example, in one non-exclusive alternative embodiment, the treatment device 14 can be a treatment chair.

In certain embodiments, the device body 22 includes a plurality of body sections that are movably coupled to one another to enable the device body 22 to be folded up for ease of transportation and/or storage. In one such embodiment, the device body 22 includes two body sections that are movably coupled to one another, e.g., with a hinge, so as to enable the device body 22 to be folded in half so that it is more compact for ease of transportation and/or storage. Alternatively, the device body 22 can include more than two body sections. Still alternatively, the device body 22 can be formed as a single body section that is not foldable.

Additionally, in one embodiment, the device body 22 is substantially rectangle-shaped. Alternatively, the device body 22 can have another suitable shape. For example, in certain non-exclusive alternative embodiments, the device body 22 can be substantially oval-shaped, oblong-shaped, rectangular-shaped with one or more rounded corners, or another suitable shape.

Further, in one embodiment, the device body 22 can include a body frame (not shown), a pad (not shown), and a covering 26. Alternatively, for example, the device body 22 can be made without the pad and/or without the covering 26.

The body frame supports the user 10 receiving the therapeutic treatment when the user 10 is positioned on the treatment device 14. The body frame is generally rigid and can be made of a rigid material such wood, aluminum, steel, plastic or other suitable materials. In alternative, non-exclusive embodiments, the body frame has a thickness of approximately 0.2, 0.3, 0.4, 0.5, 0.6, 0.7, 0.8, or 1 inches. However, other thicknesses can be utilized.

The pad is secured to and can be positioned substantially on top of the body frame. Additionally, the pad provides a cushion for the comfort of the user 10 resting on the treatment device 14. Non-exclusive examples of suitable materials for the pad include foam, memory foam, fleece pads, etc.

The covering 26 secures the pad to the body frame and provides a protective covering for the pad. Non-exclusive examples of suitable materials for the covering 26 include leather, plastic, and cloth.

Additionally, as illustrated, the treatment device 14 and/or the device body 22 can further include a headrest receiver assembly 27 that can be used to selectively secure the headrest assembly 18 to the device body 22. More particularly, in this embodiment, the headrest receiver assembly 27 is configured to receive a portion of the headrest assembly 18 so that the headrest assembly 18 is selectively coupled to the treatment device 14 and/or the device body 22. In some embodiments, the headrest receiver assembly 27 can include two spaced apart headrest receivers 27A (only one is shown in FIG. 1) that are secured to and/or integrally formed into the end 14A of the treatment device 14. It is appreciated that there can be any desired spacing between the headrest receivers 27A. In one embodiment, each of the headrest receivers 27A is a generally straight, right cylindrical-shaped aperture that extends through the end 14A of the treatment device 14. Alternatively, the headrest receiver assembly 27 can have another suitable design and/or can be positioned at another suitable location on the treatment device 14.

As noted above, the device support assembly 24 supports the device body 22 above and/or relative to the surface 16. More particularly, the device support assembly 24 extends between the device body 22 and the surface 16 to maintain the device body 22 positioned above and away from the surface 16. It is appreciated that the device support assembly 24 can have any suitable design for purposes of supporting the device body 22 above the surface 16. For example, in one embodiment, the device support assembly 24 can include one or more legs and/or feet that are fairly lightweight, but still provide desired stability for the treatment device 14. Alternatively, the device support assembly 24 can have another suitable design. Additionally, or in the alternative, the device support assembly 24 can be configured to provide one or more storage compartments, e.g., drawers, that are usable for storage of materials that can be used during any therapeutic treatments. Further, as with the device body 22, in certain embodiments, the device support assembly 24 can be configured to be foldable and/or collapsible so that the treatment device 14 can be quickly and easily folded up for ease of transportation and/or storage.

The design of the headrest assembly 18 can be varied to suit the requirements of the treatment device assembly 12 and/or the specifications of the user 10 of the treatment device assembly 12. In the embodiment illustrated in FIG. 1, the headrest assembly 18 includes a headrest 28 having a headrest support frame 30, a headrest platform 32, a headrest cushion 34, and headrest coupling arms 36, and the filter assembly 20 that is coupled to the headrest 28. Alternatively, the headrest assembly 18 can include more components or fewer components than those specifically illustrated in FIG. 1.

As an overview, the headrest assembly 18 is uniquely designed with the filter assembly 20 being coupled to the headrest 28 such that the filter assembly 20 is integrated and/or incorporated within the headrest assembly 18. As shown, the filter assembly 20 is configured and/or positioned to extend in a generally downward direction away from the headrest 28. Thus, with such design, the filter assembly 20 is configured to provide a physical (filtered) barrier between a face 10F of the user 10, i.e. when the user 10 is positioned on the treatment device 14 in a prone position, and a treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

Additionally, as described in detail herein below, it is appreciated that the filter assembly 20 can be coupled to the headrest 28 in any suitable manner. For example, in certain alternative embodiments, the filter assembly 20 can be substantially directly coupled to the headrest platform 32 and/or the filter assembly 20 can be substantially directly coupled to the headrest cushion 34. Further, the filter assembly 20 can have any suitable size and shape to suit the requirements of the treatment device 12, to suit the size and shape of the headrest 28, and/or to suit the needs of the user 10 of the treatment device 12.

The headrest 28 is configured to support a head 10H and/or the face 10F of the user 10 when the user 10 is positioned on and/or supported by the treatment device 14 and/or the headrest assembly 18. The design of the headrest 28 can be varied. As noted above, in certain embodiments, such as shown in FIG. 1, the headrest 28 can include the headrest support frame 30, the headrest platform 32, the headrest cushion 34, and the headrest coupling arms 36. One non-exclusive embodiment of a headrest 28 that is usable as part of the headrest assembly 18 is disclosed in U.S. Pat. No. 7,761,943 B2, issued to Roleder et al., the contents of which are incorporated in their entirety herein by reference.

As provided herein, in some embodiments, the headrest assembly 18 and/or the headrest 28 is removably coupled to the device body 22 of the treatment device 14, e.g., to the end 14A of the device body 22 and/or the treatment device 14, via the headrest receiver assembly 27. Alternatively, the headrest assembly 18 and/or the headrest 28 can be positioned at another location. For example, for a massage chair, the headrest assembly 18 would extend generally upward at an angle from the treatment device 14.

In various embodiments, as shown in FIG. 1, the headrest support frame 30 is configured to adjustably support the headrest platform 32 and the headrest cushion 34 relative to other portions of the headrest assembly 18. The headrest support frame 30 can have any suitable design to adjustably support the headrest platform 32 and the headrest cushion 34, and can be formed from any suitable materials. For example, in certain embodiments, the headrest support frame 30 can be formed from a relatively light weight, rigid, plastic material. Alternatively, the headrest support frame 30 can be formed from one or more of wood, aluminum, steel, or other substantially rigid materials.

Additionally, it is appreciated that the adjustability of the headrest support frame 30 can be provided in any suitable manner, e.g., via use of any suitable adjuster assembly.

The headrest platform 32 is configured to provide the desired support for the face 10F and/or head 10H of the user 10. In certain embodiments, the headrest platform 32 can be substantially flat and horseshoe-shaped. It is appreciated that the substantially horseshoe-shaped configuration of the headrest platform 32, in conjunction with the headrest cushion 34, is designed to define an opening to comfortably receive at least a portion of the face 10F and/or head 10H of the user 10. In certain embodiments, the headrest platform 32 is flexible, conforming, lightweight, and relatively inexpensive to manufacture. For example, in such embodiments, the headrest platform 32 can be formed from a flexible plastic or another suitable material. Alternatively, the headrest platform 32 can be formed from one or more of wood, aluminum, steel, or other suitable materials. Still alternatively, in some embodiments, the headrest platform 32 can be other than substantially horseshoe-shaped.

Additionally, as shown, the headrest cushion 34 is positioned on and is supported by the headrest platform 32. More specifically, as shown, the headrest cushion 34 is configured to be coupled to and/or positioned on top of and/or above the headrest platform 32, which, in turn, is adjustably supported by the headrest support frame 30. Similar to the headrest platform 32, the headrest cushion 34 can also be substantially horseshoe-shaped in order to comfortably receive at least a portion of the face 10F and/or head 10H of the user 10. In particular, the headrest cushion 34 is specifically designed to provide the user 10 with a comfortable place to rest his or her face 10F and/or head 10H when the user 10 is positioned on and/or supported by the treatment device assembly 12. Alternatively, similar to the headrest platform 32, in certain embodiments, the headrest cushion 34 can be other than substantially horseshoe-shaped. In such embodiments, it is appreciated that the shape of the headrest cushion 34 is generally configured to match the shape of the headrest platform 32.

The design and size of the headrest cushion 34 can be varied to suit the requirements of the treatment device assembly 12 and/or the specifications of the user 10 of the treatment device assembly 12. In various embodiments, the headrest cushion 34 can include one or more of a pad (not shown), and a covering 38. The pad provides a cushion for the comfort of the face 10F and/or head 10H of the user 10 resting on the support assembly 18. Non-exclusive examples of suitable materials for the pad include foam, memory foam, fleece pads, etc. Additionally, the covering 38 is positioned about the pad and provides a protective covering for the pad. Non-exclusive examples of suitable materials for the covering 38 include leather, plastic, and cloth (e.g., cotton and/or microfiber).

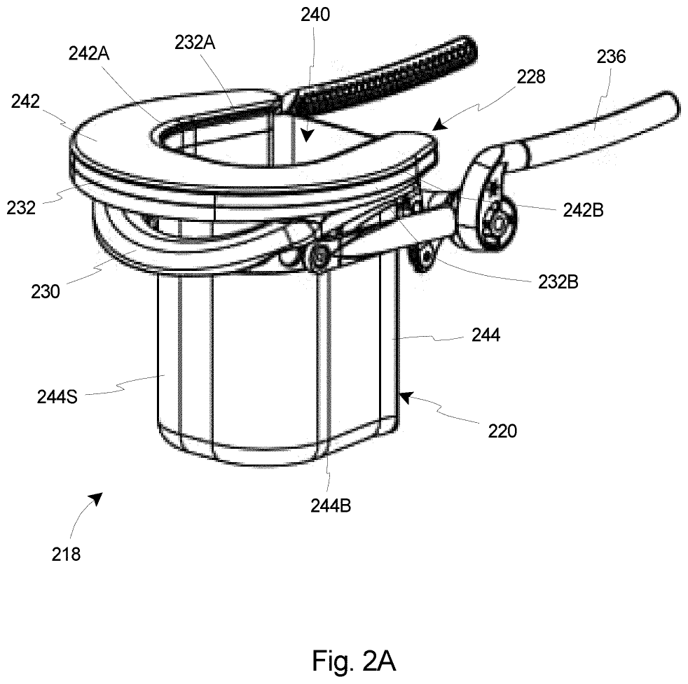

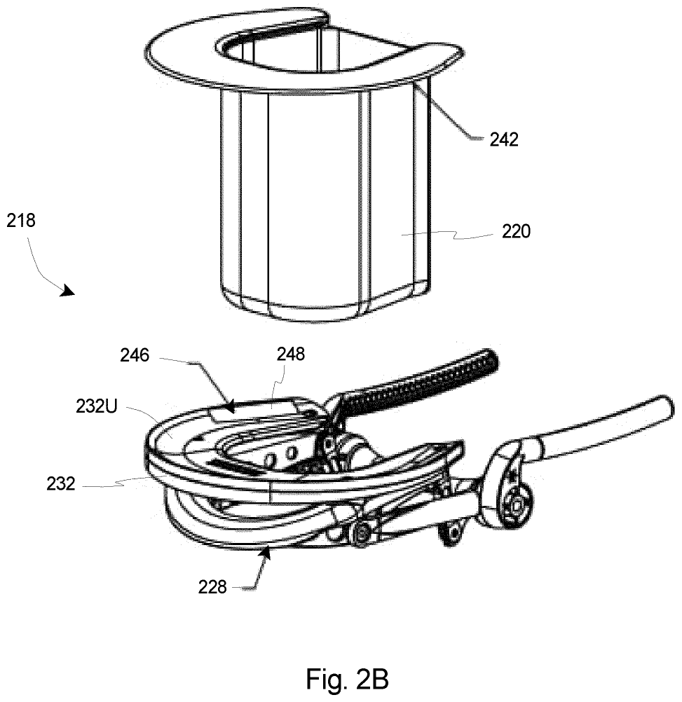

Further, in various embodiments, the substantially horseshoe-shaped design of the headrest platform 32 and the headrest cushion 34 defines an opening that is open to a filtering cavity 240 (illustrated, for example, in FIG. 2A) of any suitable or desired size, i.e. within the filter assembly 20, to provide the desired filtering protection between the user 10 and the treatment provider. It is appreciated that the headrest platform 32 and the headrest cushion 34 can have any suitable size for providing the desired comfort and convenience for the user 10 of the treatment device assembly 12.

The headrest coupling arms 36 are configured to selectively couple the headrest assembly 18 to the treatment device 14. In particular, at least a portion of each of the headrest coupling arms 36 is configured to be selectively received within one of the headrest receivers 27A of the headrest receiver assembly 27. In certain embodiments, the headrest 28 includes two spaced apart headrest coupling arms 36 (only one is shown in FIG. 1), with at least a portion of each headrest coupling arm 36 being configured to be selectively received within a corresponding headrest receiver 27A. It is appreciated that there can be any desired spacing between the headrest coupling arms 36, i.e. to match the spacing between the headrest receivers 27A.

The design, shape and length of each headrest support arm 36 can be varied depending upon the design requirements of the treatment device assembly 12 and/or the headrest assembly 18. In some embodiments, each headrest support arm 36 is a rigid, generally tubular-shaped beam that is sized and shaped to fit snugly within the corresponding headrest receiver 27A. Additionally, in one embodiment, each headrest support arm 36 can be slightly curved (e.g., somewhat arch-shaped), such that the headrest support arm 36 can fit snugly within the corresponding headrest receiver 27A regardless of how far the headrest support arm 36 is inserted into the headrest receiver 27A.

As provided herein, the filter assembly 20 is uniquely configured to provide and/or define at least a portion of the filtering cavity 240 that provides the desired filtering protection between the user 10 and the treatment provider. More specifically, as noted, the filter assembly 20 is uniquely configured to provide a physical (filtered) barrier between the face 10F of the user 10 and the treatment provider to trap respiratory particulates and to inhibit and/or filter the dispersal or spread of respiratory droplets and potentially viral aerosols between the user 10 and the treatment provider so that the user 10 does not need to wear a mask while receiving the therapeutic treatment.

Additionally, as shown, the filter assembly 20 is coupled to the headrest 28 and configured and/or positioned to extend in a generally downward direction any suitable or desired distance away from the headrest 28. Further, as described in detail herein below, it is appreciated that the filter assembly 20 can be coupled to the headrest 28 in any suitable manner. For example, in certain alternative embodiments, the filter assembly 20 can be substantially directly coupled to the headrest platform 32 and/or the filter assembly 20 can be substantially directly coupled to the headrest cushion 34. Further, the filter assembly 20 can be configured to extend generally downward from an inner edge or an outer edge of the headrest platform 32 and/or headrest cushion 34.

The filter assembly 20 can be formed from any suitable materials to provide the desired filtering functions between the face 10F of the user 10 and the treatment provider, i.e. between the environment inside the filtering cavity 240 and the ambient environment outside the filtering cavity 240 as defined at least in part by the filter assembly 20. For example, in certain non-exclusive embodiments, the filter assembly 20 can be formed at least in part from a flexible fabric material, such as cotton and/or microfiber. Additionally, or in the alternative, the filter assembly 20 can be formed from other suitable materials. For example, in some other non-exclusive alternative embodiments, the filter assembly 20 can be formed from one or more of synthetic plastic fibers such as polypropylene and polyester. In certain implementations, the filter assembly 20 is at least partly resilient and stretchable. Further, as discussed below, the filter assembly 20 can form a filtering cavity (with the face of the user and/or the headrest) for capturing and filtering the breath of the user.

It is appreciated that, in some embodiments, the filter assembly 20 can be formed from materials that enable the filter assembly 20 to be reusable, machine-washable, and wrinkle-resistant.

It is further appreciated that, in certain embodiments, the filter assembly 20 can be formed from the same materials as the covering 38 of the headrest cushion 34. Alternatively, in other embodiments, the filter assembly 20 can be formed from materials that are different than the materials of the covering 38 of the headrest cushion 34.

Various alternative embodiments of the filter assembly 20 will be illustrated and described in greater detail herein below. Additionally, it is appreciated that each embodiment of the filter assembly 20 illustrated and described herein is usable in conjunction with the headrest 28 such as described herein above as part of the headrest assembly 18. Further, or in the alternative, it is also appreciated that the embodiments of the filter assembly 20 described herein can be used with other headrests having a different design.

FIG. 2A is a simplified perspective view of a portion of an embodiment of the headrest assembly 218 including an embodiment of the filter assembly 220. In this embodiment, the headrest assembly 218 again includes a headrest 228 having a headrest support frame 230, a headrest platform 232, a headrest cushion (not shown in FIG. 2A for purposes of clarity), and headrest support arms 236 that are substantially similar in design and function as those illustrated and described herein above. Accordingly, such components of the headrest 228 will not be described again in detail.

As shown in the embodiment illustrated in FIG. 2A, the filter assembly 220 includes a filter connector 242, and a filter body 244 that is coupled to and/or integrally formed with the filter connector 242 and that is configured to extend generally downward from the filter connector 242 when the filter assembly 220 is coupled to the headrest 228. In some embodiments, the filter connector 242 is provided in the form of a filter connection platform, which can be sized and shaped to ensure effective coupling between the filter assembly 220 and the headrest 228. Alternatively, in other embodiments, the filter connector 242 can have another suitable design for purposes of coupling the filter assembly 220 to the headrest 228. For example, in one such non-exclusive alternative embodiment, the filter connector 242 can be provided in the form of an elastic strap or band that is coupled to the filter body 244, and that is configured to be positioned around at least a portion of the headrest 228, such as the headrest platform 232 or the headrest cushion.

Additionally, as shown, the filter assembly 220 and/or the filter body 244 defines at least a portion of the filtering cavity 240, i.e. formed inside sides 244S and a base 244B of the filter body 244, that is configured to be positioned substantially directly beneath the head 10H (illustrated in FIG. 1) and/or face 10F (illustrated in FIG. 1) of the user 10 (illustrated in FIG. 1) when the user 10 is positioned on and/or supported by the treatment device 14 (illustrated in FIG. 1) and/or the headrest assembly 218. As provided herein, the inclusion of the filtering cavity 240 as defined at least in part by the filter assembly 220 and/or the filter body 244 provides certain advantages with regard to comfort and convenience for the user 10 of the treatment device assembly 12 (illustrated in FIG. 1). For example, as noted herein, the presence of the filtering cavity 240 enables advantages such as providing a physical (filtered) barrier between the face 10F of the user 10 and the treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment. Additionally, in certain implementations, the filtering cavity 240 can further provide a receptacle into which the user 10 or the treatment provider can insert essential oils, fragrances, aromatherapy pads and/or aesthetically pleasing decorations to further enhance the experience for the user 10.

In this embodiment, the filter connector 242 is provided in the form of a filter connection platform that is removably coupled to the headrest platform 232 such that when the headrest assembly is fully assembled, the filter connector 242 is positioned substantially between the headrest platform 232 and the headrest cushion 34 (illustrated in FIG. 1). More particularly, in certain embodiments, the filter connector 242 can be removably coupled to the headrest platform 232 with a coupling assembly 246 (illustrated, for example, in FIG. 2B). It is appreciated that the coupling assembly 246 can have any suitable design for purposes of selectively coupling the filter connector 242 to the headrest platform 232. Alternatively, in other embodiments, the filter connector 242 can be selectively coupled to the headrest cushion 34. Still alternatively, in still other embodiments, the filter connector 242 can be specifically configured to incorporate features that enable the selective coupling of the filter assembly 220 to the headrest 228, such as when the filter connector 242 is provided in the form of an elastic strap or band that can be positioned around at least a portion of the headrest 228.

Additionally, as shown, in certain embodiments, the filter connector 242 can be substantially horseshoe-shaped to match the size and shape of the headrest platform 232. Additionally, with such design, the filter connector 242 includes an inner edge 242A and an outer edge 242B that correspond with an inner edge 232A (illustrated more clearly in FIG. 2B) and an outer edge 232B of the headrest platform 232. Alternatively, the filter connector 242 can be configured to have another suitable shape, e.g., to match the shape of the headrest platform 232 and/or the headrest cushion 234.

As shown, in various embodiments, the inner edge 242A of the filter connector 242, the outer edge 242B of the filter connector 242, the inner edge 232A of the headrest platform 232, and the outer edge 232B of the headrest platform 232 can be substantially or generally arch-shaped to match the substantially horseshoe-shaped design of the filter connector 242 and the headrest platform 232. Alternatively, the inner edge 242A of the filter connector 242, the outer edge 242B of the filter connector 242, the inner edge 232A of the headrest platform 232, and/or the outer edge 232B of the headrest platform 232 can have other suitable shapes.

The filter connector 242 can be formed from any suitable materials. For example, in certain embodiments, the filter connector 242 can be formed from one or more of leather, plastic, cloth (e.g., cotton and/or microfiber), or other suitable materials. Alternatively, in other embodiments, the filter connector 242 can be formed from one or more of wood, aluminum, steel or other suitable rigid materials. Still alternatively, in still other embodiments, the filter connector 242 can include and/or be formed from an elastic material.

In this embodiment, as illustrated in FIG. 2A, the filter body 244 extends in a generally downward direction from the inner edge 242A of the filter connector 242 (and, thus, the filter body 244 also extends in a generally downward direction from the inner edge 232A of the headrest platform 232). Alternatively, in other embodiments, the filter body 244 can extend in a generally downward direction from the outer edge 242B of the filter connector 242 (and, thus, the filter body 244 can also extend in a generally downward direction from the outer edge 232B of the headrest platform 232).

Additionally, as noted, the filter body 244 defines at least a portion of the filtering cavity 240 that is formed within the filter body 244. Further, the filter body 244 can be formed from any suitable materials. For example, in certain embodiments, the filter body 244 can be formed from one or more materials, such as cotton and/or microfiber, that are specifically configured to filter the respiratory droplets and/or aerosols from the user 10. Alternatively, the filter body 244 can be formed from other suitable filtering materials. For example, in some other non-exclusive alternative embodiments, the filter body 244 can be formed from one or more of synthetic plastic fibers such as polypropylene and polyester.

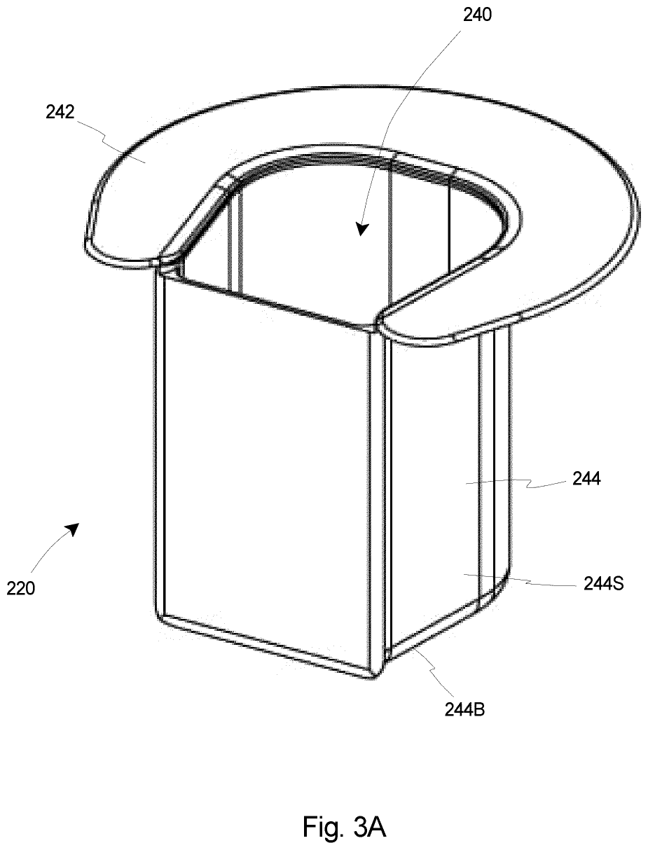

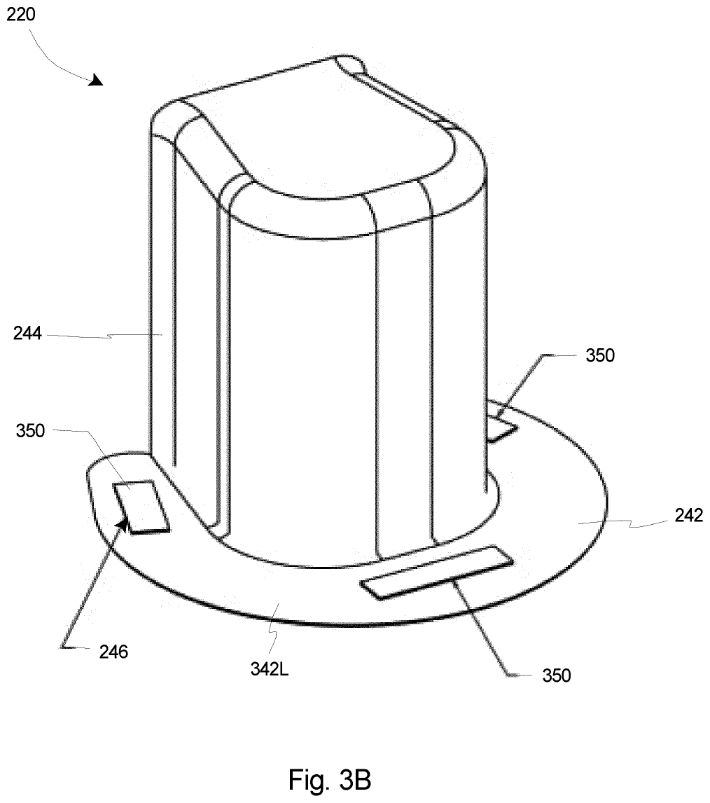

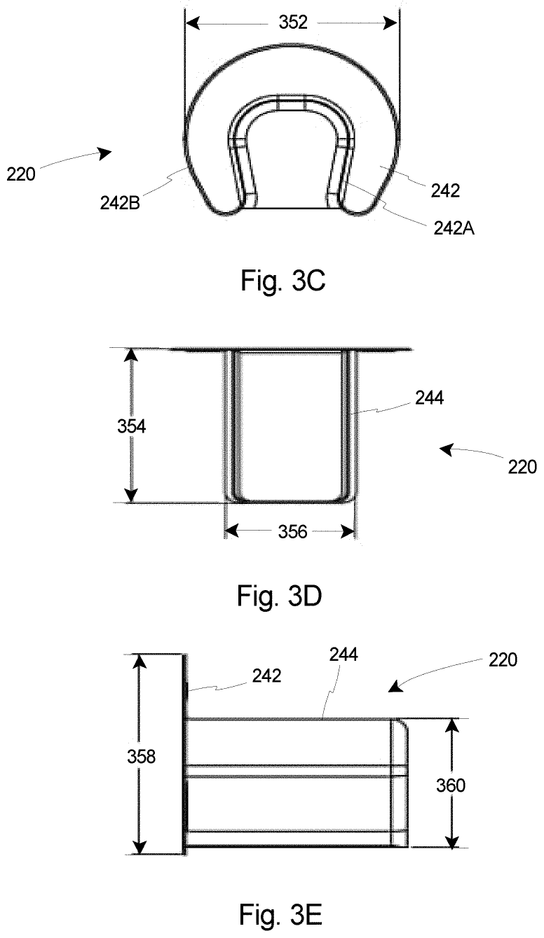

The filter connector 242 and the filter body 244 can have any suitable size and shape, certain embodiments (i.e. dimensions) of which will be described in greater detail herein below in relation to FIGS. 3A-3E.

FIG. 2B is a partially exploded view of the portion of the headrest assembly 218 illustrated in FIG. 2A. In particular, FIG. 2B again shows that the headrest assembly 218 includes the headrest 228, and the filter assembly 220 that is configured to be selectively coupled to the headrest 228.

Additionally, as noted above, FIG. 2B also illustrates a portion of an embodiment of the coupling assembly 246 that is usable for purposes of selectively coupling the filter assembly 220 to the headrest 228, i.e. to the headrest platform 232 in this particular embodiment. In certain embodiments, the coupling assembly 246 includes one or more first coupling members 248 that are secured to the headrest platform 232, such as to an upper surface 232U of the headrest platform 232, and one or more second coupling members 350 (illustrated in FIG. 3B) that are secured to the filter connector 242. In such embodiments, each of the one or more first coupling members 248 is configured and/or positioned to engage one of the second coupling members 350 during the selective coupling between the filter assembly 220, i.e. the filter connector 242, and the headrest platform 232. In one such embodiment, each of the one or more first coupling members 248 can be a piece of hook-and-loop material, and each of the one or more second coupling members 350 can also be a piece of hook-and-loop material that is configured and/or positioned to engage one of the first coupling members 248 during the selective coupling between the filter assembly 220, i.e. the filter connector 242, and the headrest platform 232. Alternatively, the coupling assembly 246, the one or more first coupling members 248 and/or the one or more second coupling members 350 can have another suitable design.

It is appreciated that the use of the terms “first coupling members” and “second coupling members” is merely for purposes of simplicity and ease of illustration, and either set of coupling members 248, 350 can be referred to as the “first coupling members” and/or the “second coupling members”.

FIG. 3A is a simplified top perspective view of the filter assembly 220 illustrated in FIG. 2A. In particular, FIG. 3A illustrates a top perspective view of the filter assembly 220 including the filter connector 242, and the filter body 244. Additionally, FIG. 3A further illustrates the filtering cavity 240 that is defined at least in part by the base 244B and sides 244S of the filter body 244.

FIG. 3B is a simplified bottom perspective view of the filter assembly 220 illustrated in FIG. 3A. In particular, FIG. 3B illustrates a bottom perspective view of the filter assembly 220 including the filter connector 242, and the filter body 244. Additionally, FIG. 3B further illustrates the one or more second coupling members 350, e.g., hook-and-loop material in one embodiment, that make up a portion of the coupling assembly 246 and that are configured and positioned to engage the one or more first coupling members 248 (illustrated in FIG. 2B) during the selective coupling between the filter connector 242 and the headrest platform 232 (illustrated in FIG. 2A).

FIGS. 3C-3E are simplified alternative views of the filter assembly 220 illustrated in FIG. 3A, which illustrate certain potential dimensions of the components of the filter assembly 220. More specifically, FIG. 3C is a simplified top view of the filter assembly 220 illustrated in FIG. 3A; FIG. 3D is a simplified front view of the filter assembly 220 illustrated in FIG. 3A; and FIG. 3E is a simplified side view of the filter assembly 220 illustrated in FIG. 3A.

In FIG. 3C, a mount width 352 of the filter connector 242 is illustrated. In certain non-exclusive embodiments, the filter connector 242 can have a mount width 352 of between approximately seven inches and 13 inches. In one such embodiment, the filter connector 242 has a mount width 352 of approximately ten inches. Alternatively, in other embodiments, the filter connector 242 can have a mount width 352 of greater than 13 inches or less than seven inches.

Additionally, FIG. 3C also clearly illustrates the inner edge 242A and the outer edge 242B of the filter connector 242.

FIG. 3D illustrates a filter height 354 and a filter width 356 of the filter body 244 of the filter assembly 220. In certain non-exclusive embodiments, the filter body 244 can have a filter height 354 of between approximately six inches and 11 inches. In one such embodiment, the filter body 244 can have a filter height 354 of approximately 8.4 inches. Alternatively, in other embodiments, the filter body 244 can have a filter height 354 of greater than 11 inches or less than six inches.

Additionally, in some non-exclusive embodiments, the filter body 244 can have a filter width 356 of between approximately four inches and seven inches. In one such embodiment, the filter body 244 can have a filter width 356 of approximately 5.5 inches. Alternatively, in other embodiments, the filter body 244 can have a filter width 356 of greater than seven inches or less than four inches.

FIG. 3E illustrates a mount length 358 of the filter connector 242, and a filter length 360 of the filter body 244. In certain non-exclusive embodiments, the filter connector 242 can have a mount length 358 of between approximately six inches and 12 inches. In one such embodiment, the filter connector 242 can have a mount length 358 of approximately nine inches. Alternatively, in other embodiments, the filter connector 242 can have a mount length 358 of greater than 12 inches or less than six inches.

Additionally, in some non-exclusive embodiments, the filter body 244 can have a filter length 360 of between approximately four inches and seven inches. In one such embodiment, the filter body 244 can have a filter length 360 of approximately 5.7 inches. Alternatively, in other embodiments, the filter body 244 can have a filter length 360 of greater than seven inches or less than four inches.

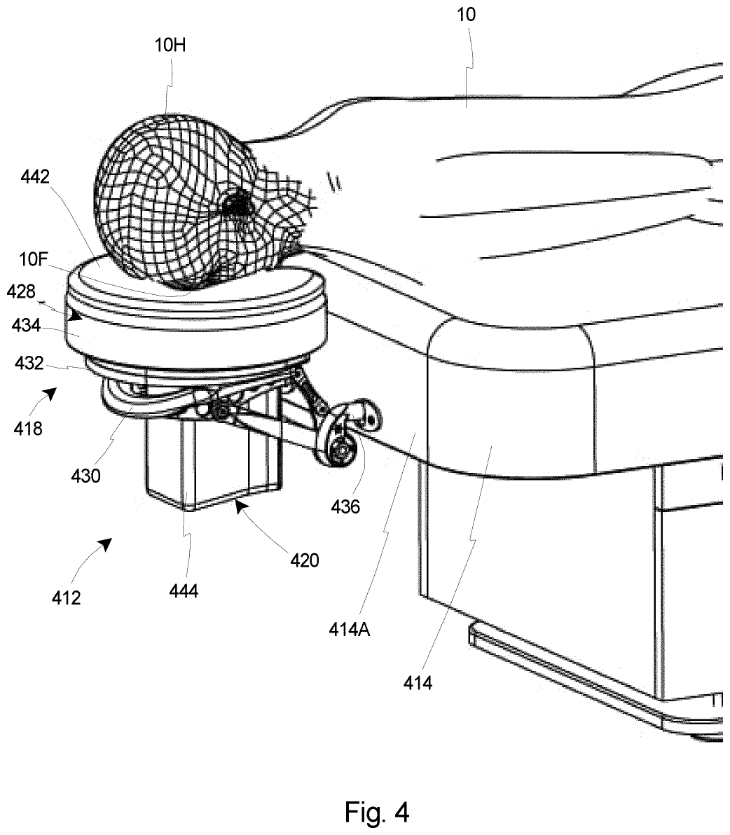

FIG. 4 is a simplified perspective view of a user 10 and a portion of another embodiment of the treatment device assembly 412 including a headrest assembly 418 having another embodiment of the filter assembly 420 incorporated therein. As above, the treatment device assembly 412 includes a treatment device 414 and the headrest assembly 418, including the headrest 428 and the filter assembly 420, that is selectively coupled to the treatment device 414, e.g., to an end 414A of the treatment device 414. Additionally, as above, the headrest assembly 418 is configured to support the head 10H and/or face 10F of the user 10 when the user is positioned on the treatment device assembly 412. Further, as shown, the filter assembly 420 is integrated and/or incorporated within the headrest assembly 418 such that the filter assembly 420 extends in a generally downward direction from the headrest 428 to provide a physical (filtered) barrier between the face 10F of the user 10 and a treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

The treatment device 414 is substantially similar in design and function to the treatment device 14 illustrated and described herein above. Accordingly, the treatment device 414 will not be described in detail again herein.

Additionally, the headrest 428 is also substantially similar in design and function to the headrest 28 illustrated and described herein above. For example, the headrest 428 again includes a headrest support frame 430, a headrest platform 432, a headrest cushion 434, and headrest support arms 436 that are substantially similar to the corresponding components illustrated and described herein above. Accordingly, the components of the headrest 428 will not be described in detail again herein.

Further, the filter assembly 420 is somewhat similar to the previous embodiments. For example, the filter assembly 420 again includes a filter connector 442 and the filter body 444 that are somewhat similar in general design and function to the previous embodiments. However, as illustrated, the filter assembly 420 is somewhat different than the embodiment illustrated and described herein above. In particular, as described in greater detail herein below, in the embodiment illustrated in FIG. 4, the filter assembly 420 is configured to be selectively coupled to the headrest cushion 434. More specifically, the filter assembly 420 includes the filter connector 442 that is mounted substantially directly on top of the headrest cushion 434 (instead of being coupled to the headrest platform and positioned substantially between the headrest platform and the headrest cushion as in the previous embodiment).

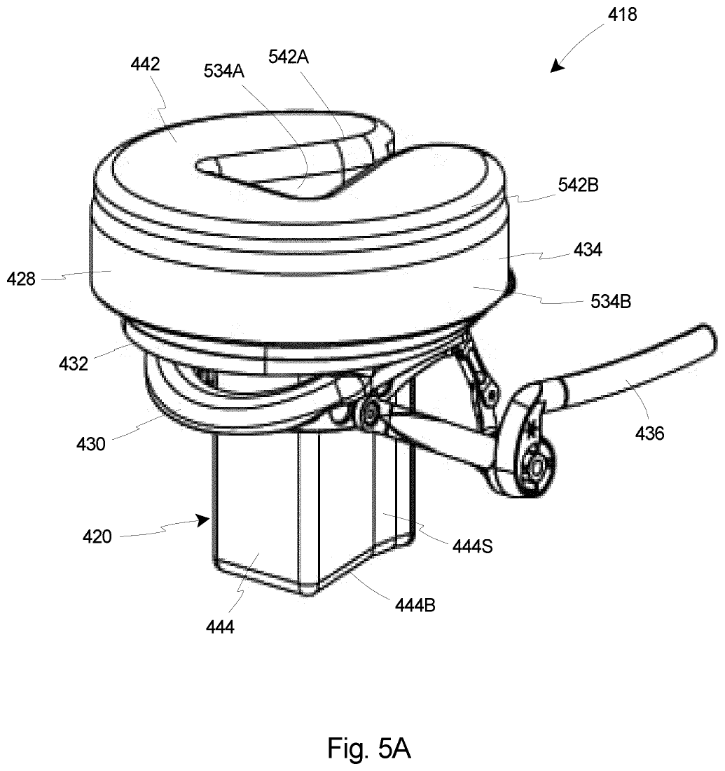

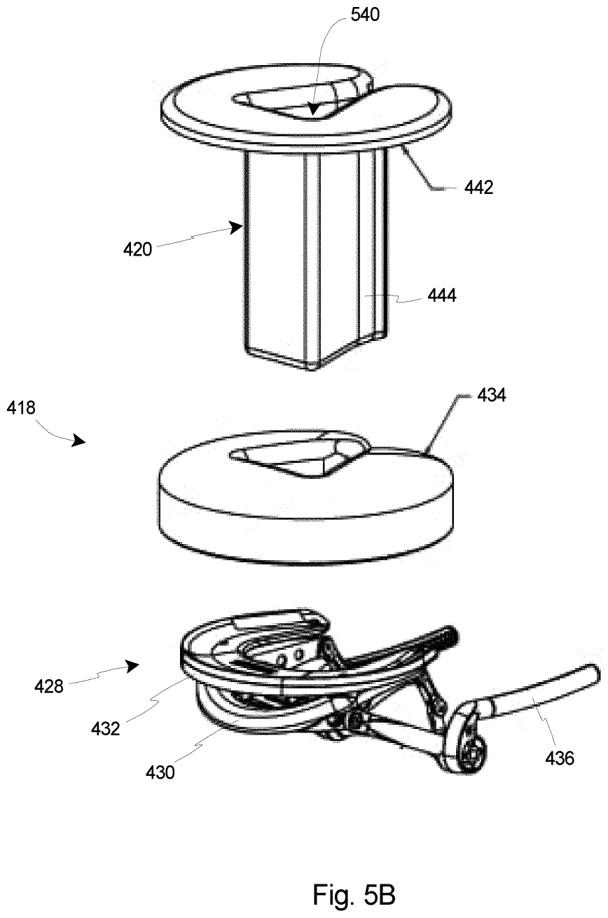

FIG. 5A is a simplified perspective view of the headrest assembly 418 including the embodiment of the filter assembly 420 illustrated in FIG. 4. In particular, FIG. 5A again illustrates that the headrest assembly 418 includes the headrest 428 having the headrest support frame 430, the headrest platform 432, the headrest cushion 434, and the headrest support arms 436; and the filter assembly 420 that is coupled to the headrest 428 so as to be integrated and/or incorporated into the headrest assembly 418.

As noted above, in this embodiment, the filter assembly 420 again includes the filter connector 442, and the filter body 444 that is coupled to and/or integrally formed with the filter connector 442 and that extends generally downward from the filter connector 442. Additionally, the filter assembly 420 and/or the filter body 444 again defines at least a portion of a filtering cavity 540 (illustrated, for example, in FIG. 5B), i.e. formed inside sides 444S and a base 444B of the filter body 444, that is configured to be positioned substantially directly beneath the head 10H (illustrated in FIG. 4) and/or face 10F (illustrated in FIG. 4) of the user 10 (illustrated in FIG. 4) when the user 10 is positioned on and/or supported by the treatment device 414 (illustrated in FIG. 4) and/or the headrest assembly 418. As provided herein, the inclusion of the filtering cavity 540 as defined at least in part by the filter assembly 420 and/or the filter body 444 again enables advantages such as providing a physical (filtered) barrier between the face 10F of the user 10 and the treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

As further noted above, in this embodiment, the filter connector 442 is mounted substantially directly on top of the headrest cushion 434 of the headrest 428. Alternatively, in other embodiments, the filter connector 442 can be selectively coupled to the headrest 428 in another suitable manner.

Additionally, similar to the previous embodiments, the filter connector 442 can again be substantially horseshoe-shaped, in this instance to match the size and shape of the substantially horseshoe-shaped headrest cushion 434. More particularly, with such design, the filter connector 442 includes an inner edge 542A and an outer edge 542B that correspond with an inner edge 534A (illustrated more clearly in FIG. 5B) and an outer edge 534B of the headrest cushion 434.

As shown, in various embodiments, the inner edge 542A of the filter connector 442, the outer edge 542B of the filter connector 442, the inner edge 534A of the headrest cushion 434, and the outer edge 534B of the headrest cushion 434 can be substantially or generally arch-shaped to match the substantially horseshoe-shaped design of the filter connector 442 and the headrest cushion 434. Alternatively, the inner edge 542A of the filter connector 442, the outer edge 542B of the filter connector 442, the inner edge 534A of the headrest cushion 434, and/or the outer edge 534B of the headrest cushion 434 can have other suitable shapes.

The filter connector 442 can be formed from any suitable materials. For example, in certain embodiments, the filter connector 442 can be formed from one or more of leather, plastic, cloth (e.g., cotton and/or microfiber), or other suitable materials.

In this embodiment, as illustrated in FIG. 5A, the filter body 444 extends in a generally downward direction from the inner edge 542A of the filter connector 442 (and, thus, the filter body 444 also extends in a generally downward direction from the inner edge 534A of the headrest cushion 434). Alternatively, in other embodiments, the filter body 444 can extend in a generally downward direction from the outer edge 542B of the filter connector 442 (and, thus, the filter body 444 can also extend in a generally downward direction from the outer edge 534B of the headrest cushion 434).

Additionally, as noted, the filter body 444 defines at least a portion of the filtering cavity 540 that is formed within the filter body 444. Further, the filter body 444 can be formed from any suitable materials. For example, in certain embodiments, the filter body 444 can be formed from one or more materials, such as cotton and/or microfiber, that are specifically configured to filter the respiratory droplets and/or aerosols from the user 10. Alternatively, the filter body 444 can be formed from other suitable filtering materials. For example, in some other non-exclusive alternative embodiments, the filter body 444 can be formed from one or more of synthetic plastic fibers such as polypropylene and polyester.

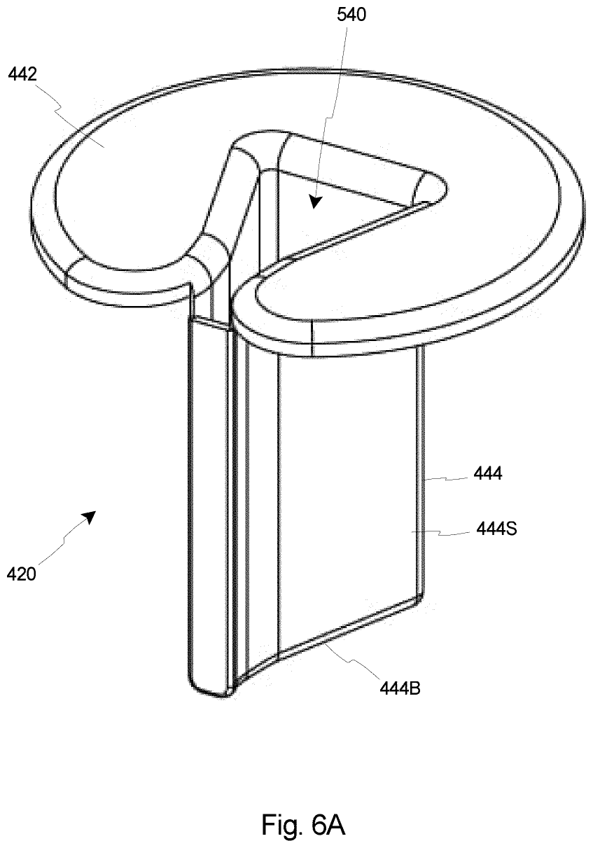

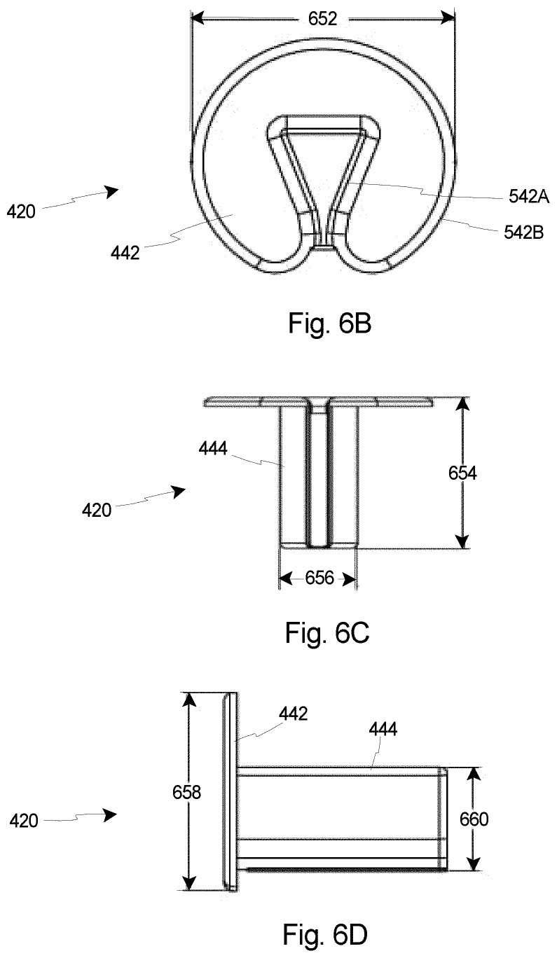

The filter connector 442 and the filter body 444 can have any suitable size and shape, certain embodiments (i.e. dimensions) of which will be described in greater detail herein below in relation to FIGS. 6A-6D.

FIG. 5B is a partially exploded view of the headrest assembly 418 illustrated in FIG. 5A. In particular, FIG. 5B again shows that the headrest assembly 418 includes the headrest 428 having the headrest support frame 430, the headrest platform 432, the headrest cushion 434, and the headrest support arms 436, and the filter assembly 420 that is configured to be selectively coupled to the headrest 428.

Additionally, FIG. 5B also more clearly illustrates the filter connector 442 and the filter body 444 of the filter assembly 420, which define at least a portion of the filtering cavity 540 that is formed largely within the filter body 444.

FIG. 6A is a simplified perspective view of the filter assembly 420 illustrated in FIG. 5A. In particular, FIG. 6A illustrates a perspective view of the filter assembly 420 including the filter connector 442, and the filter body 444. Additionally, FIG. 6A further illustrates the filtering cavity 540 that is defined at least in part by the base 444B and sides 444S of the filter body 444.

FIGS. 6B-6D are simplified alternative views of the filter assembly 420 illustrated in FIG. 6A, which illustrate certain potential dimensions of the components of the filter assembly 420. More specifically, FIG. 6B is a simplified top view of the filter assembly 420 illustrated in FIG. 6A; FIG. 6C is a simplified front view of the filter assembly 420 illustrated in FIG. 6A; and FIG. 6D is a simplified side view of the filter assembly 420 illustrated in FIG. 6A.

In FIG. 6B, a mount width 652 of the filter connector 442 is illustrated. In certain non-exclusive embodiments, the filter connector 442 can have a mount width 652 of between approximately nine inches and 14 inches. In one such embodiment, the filter connector 442 has a mount width 652 of approximately 11.6 inches. Alternatively, in other embodiments, the filter connector 442 can have a mount width 652 of greater than 14 inches or less than nine inches.

Additionally, FIG. 6B also clearly illustrates the inner edge 542A and the outer edge 542B of the filter connector 442.

FIG. 6C illustrates a filter height 654 and a filter width 656 of the filter body 444 of the filter assembly 420. In certain non-exclusive embodiments, the filter body 444 can have a filter height 654 of between approximately eight inches and 13 inches. In one such embodiment, the filter body 444 can have a filter height 654 of approximately 10.2 inches. Alternatively, in other embodiments, the filter body 444 can have a filter height 654 of greater than 13 inches or less than eight inches.

Additionally, in some non-exclusive embodiments, the filter body 444 can have a filter width 656 of between approximately 2.5 inches and 5.5 inches. In one such embodiment, the filter body 444 can have a filter width 656 of approximately 3.9 inches. Alternatively, in other embodiments, the filter body 444 can have a filter width 656 of greater than 5.5 inches or less than 2.5 inches.

FIG. 6D illustrates a mount length 658 of the filter connector 442, and a filter length 660 of the filter body 444. In certain non-exclusive embodiments, the filter connector 442 can have a mount length 658 of between approximately eight inches and 14 inches. In one such embodiment, the filter connector 442 can have a mount length 658 of approximately 11 inches. Alternatively, in other embodiments, the filter connector 442 can have a mount length 658 of greater than 14 inches or less than eight inches.

Additionally, in some non-exclusive embodiments, the filter body 444 can have a filter length 660 of between approximately four inches and seven inches. In one such embodiment, the filter body 444 can have a filter length 660 of approximately 5.8 inches. Alternatively, in other embodiments, the filter body 444 can have a filter length 660 of greater than seven inches or less than four inches.

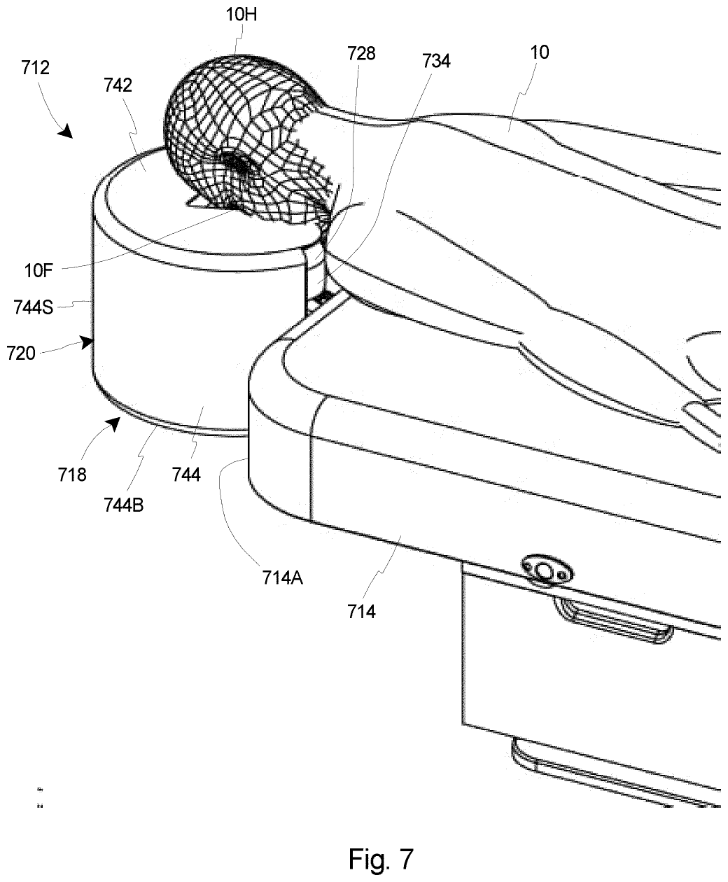

FIG. 7 is a simplified perspective view of a user 10 and a portion of still another embodiment of the treatment device assembly 712 including a headrest assembly 718 having still another embodiment of the filter assembly 720 incorporated therein. As above, the treatment device assembly 712 includes a treatment device 714 and the headrest assembly 718, including the headrest 728 and the filter assembly 720, that is selectively coupled to the treatment device 714, e.g., to an end 714A of the treatment device 714. Additionally, as above, the headrest assembly 718 is configured to support the head 10H and/or face 10F of the user 10 when the user is positioned on the treatment device assembly 712. Further, as shown, the filter assembly 720 is integrated and/or incorporated within the headrest assembly 718 such that the filter assembly 720 extends in a generally downward direction from the headrest 728 to provide a physical (filtered) barrier between the face 10F of the user 10 and a treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

The treatment device 714 is substantially similar in design and function to the embodiments illustrated and described herein above. Accordingly, the treatment device 714 will not be described in detail again herein.

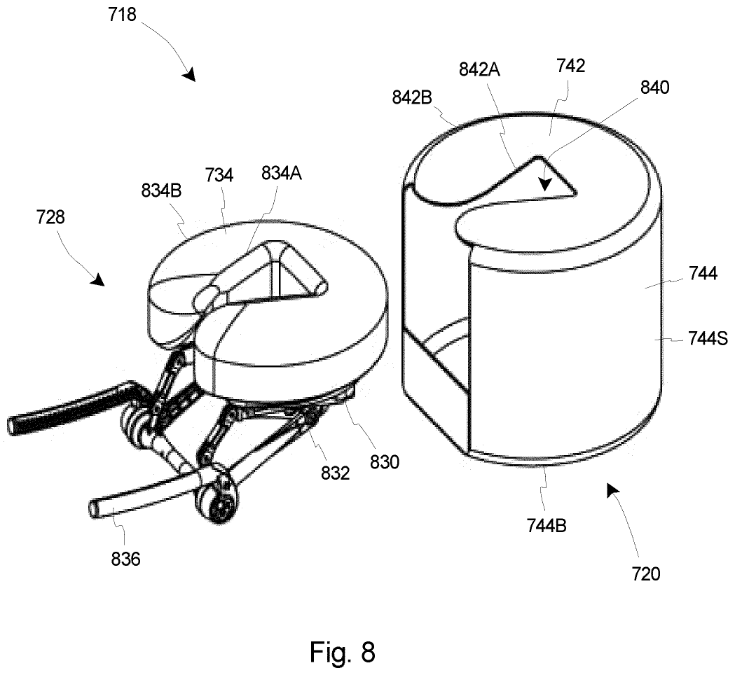

Additionally, the headrest 728 is also substantially similar in design and function to the embodiments illustrated and described herein above. For example, the headrest 728 can again include a headrest support frame 830 (illustrated in FIG. 8), a headrest platform 832 (illustrated in FIG. 8), a headrest cushion 734, and headrest support arms 836 (illustrated in FIG. 8) that are substantially similar to the corresponding components illustrated and described herein above. Accordingly, the components of the headrest 728 will not be described in detail again herein.

Further, the filter assembly 720 is somewhat similar to the previous embodiments. For example, the filter assembly 720 again includes a filter connector 742 and the filter body 744 that are somewhat similar in general design and function to the previous embodiments. However, as illustrated, the filter assembly 720 is somewhat different than the embodiments illustrated and described herein above. In particular, as described in greater detail herein below, in the embodiment illustrated in FIG. 7, the filter assembly 720 is again configured to be selectively coupled to the headrest cushion 734. More specifically, the filter assembly 720 includes the filter connector 742 that is mounted substantially directly on top of the headrest cushion 734. Additionally, in this embodiment, the filter body 744 is configured and/or positioned to substantially surround the headrest cushion 734 and a large portion of the remainder of the headrest 728. Stated in another manner, a substantial portion of the headrest 728 is positioned within the filtering cavity 840 (illustrated in FIG. 8) that is defined at least in part by the filter connector 742 and the filter body 744, i.e. the base 744B and the sides 744S of the filter body 744. It is appreciated that a majority of the headrest 728 is not visible in FIG. 7 because the headrest 728 is substantially positioned within the filtering cavity 840.

FIG. 8 is a partially exploded view of the headrest assembly 718 including the embodiment of the filter assembly 720 illustrated in FIG. 7. In particular, FIG. 8 again illustrates that the headrest assembly 718 includes the headrest 728 having the headrest support frame 830, the headrest platform 832, the headrest cushion 734, and the headrest support arms 836; and the filter assembly 720 that is coupled to the headrest 728 so as to be integrated and/or incorporated into the headrest assembly 718. Additionally, in this embodiment, the filter assembly 720 again includes the filter connector 742, and the filter body 744 that is coupled to and/or integrally formed with the filter connector 742 and that extends generally downward from the filter connector 742. Further, the filter assembly 720 and/or the filter connector 742 and the filter body 744 again defines at least a portion of the filtering cavity 840, i.e. formed inside the sides 744S and the base 744B of the filter body 744, that is configured to be positioned substantially directly beneath the head 10H (illustrated in FIG. 7) and/or face 10F (illustrated in FIG. 7) of the user 10 (illustrated in FIG. 7) when the user 10 is positioned on and/or supported by the treatment device 714 (illustrated in FIG. 7) and/or the headrest assembly 718. As provided herein, the inclusion of the filtering cavity 840 again enables advantages such as providing a physical (filtered) barrier between the face 10F of the user 10 and the treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

Additionally, in this embodiment, the filter connector 742 is configured to be mounted substantially directly on top of the headrest cushion 734 of the headrest 728. Alternatively, in other embodiments, the filter connector 742 can be selectively coupled to the headrest 728 in another suitable manner.

Further, similar to the previous embodiments, the filter connector 742 can again be substantially horseshoe-shaped, in this instance to match the size and shape of the substantially horseshoe-shaped headrest cushion 734. More particularly, with such design, the filter connector 742 includes an inner edge 842A and an outer edge 842B that correspond with an inner edge 834A and an outer edge 834B of the headrest cushion 734.

The filter connector 742 can be formed from any suitable materials. For example, in certain embodiments, the filter connector 742 can be formed from one or more of leather, plastic, cloth (e.g., cotton and/or microfiber), or other suitable materials.

In this embodiment, as illustrated in FIG. 8, the filter body 744 extends in a generally downward direction from the outer edge 842B of the filter connector 742 (and, thus, the filter body 744 also extends in a generally downward direction from the outer edge 834B of the headrest cushion 734).

Further, as noted above, the filter body 744 can be formed from any suitable materials. For example, in certain embodiments, the filter body 744 can be formed from one or more materials, such as cotton and/or microfiber, that are specifically configured to filter the respiratory droplets and/or aerosols from the user 10. Alternatively, the filter body 744 can be formed from other suitable filtering materials. For example, in some other non-exclusive alternative embodiments, the filter body 744 can be formed from one or more of synthetic plastic fibers such as polypropylene and polyester.

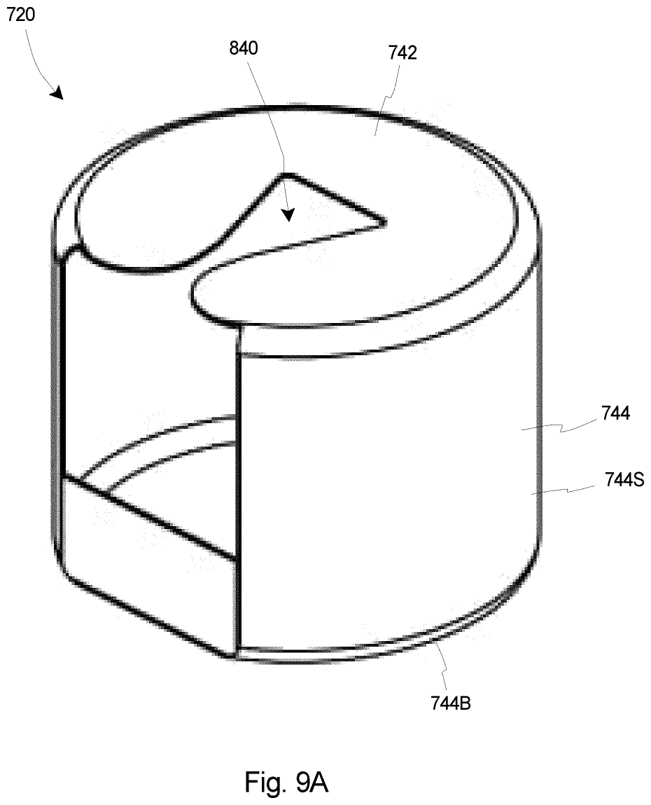

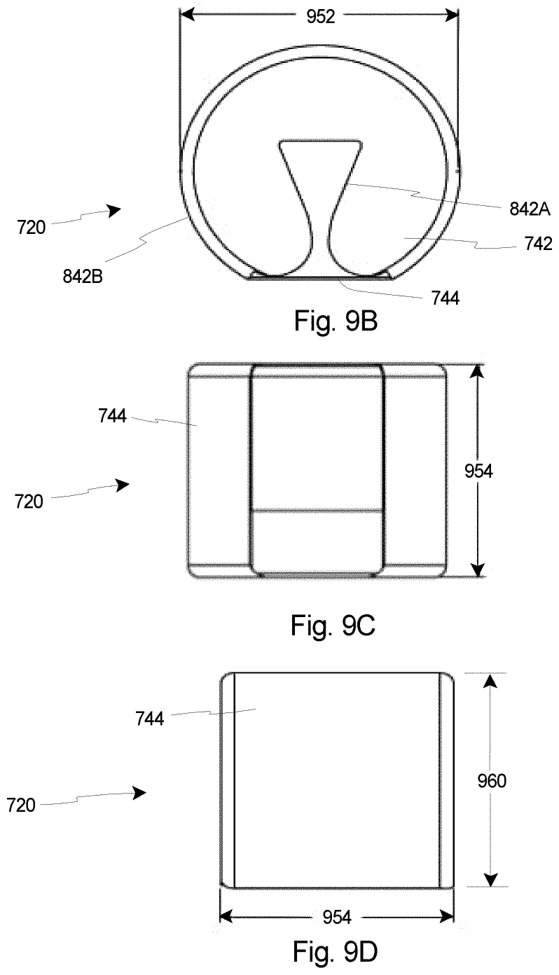

The filter connector 742 and the filter body 744 can have any suitable size and shape, certain embodiments (i.e. dimensions) of which will be described in greater detail herein below in relation to FIGS. 9A-9D.

FIG. 9A is a simplified perspective view of the filter assembly 720 illustrated in FIG. 8. In particular, FIG. 9A illustrates a perspective view of the filter assembly 720 including the filter connector 742, and the filter body 744. Additionally, FIG. 9A further illustrates the filtering cavity 840 that is defined at least in part by the base 744B and sides 744S of the filter body 744.

FIGS. 9B-9D are simplified alternative views of the filter assembly 720 illustrated in FIG. 9A, which illustrate certain potential dimensions of the components of the filter assembly 720. More specifically, FIG. 9B is a simplified top view of the filter assembly 720 illustrated in FIG. 9A; FIG. 9C is a simplified front view of the filter assembly 720 illustrated in FIG. 9A; and FIG. 9D is a simplified side view of the filter assembly 720 illustrated in FIG. 9A.

In FIG. 9B, a mount width 952 of the filter connector 742 is illustrated. In certain non-exclusive embodiments, the filter connector 742 can have a mount width 952 of between approximately ten inches and 15 inches. In one such embodiment, the filter connector 742 has a mount width 952 of approximately 12.7 inches. Alternatively, in other embodiments, the filter connector 742 can have a mount width 952 of greater than 15 inches or less than ten inches.

Based on the design of the filter assembly 720 in this embodiment, it is appreciated that a filter width of the filter body 744 would be substantially the same as the mount width 952 of the filter connector 742.

Additionally, FIG. 9B also clearly illustrates the inner edge 842A and the outer edge 842B of the filter connector 742.

FIG. 9C illustrates a filter height 954 of the filter body 744 of the filter assembly 720. In certain non-exclusive embodiments, the filter body 744 can have a filter height 954 of between approximately ten inches and 15 inches. In one such embodiment, the filter body 744 can have a filter height 954 of approximately 12.7 inches. Alternatively, in other embodiments, the filter body 744 can have a filter height 954 of greater than 15 inches or less than ten inches.

FIG. 9D also illustrates the filter height 954 of the filter body 744 of the filter assembly 720. Additionally, FIG. 9D further illustrates a filter length 960 of the filter body 744. In certain non-exclusive embodiments, the filter body 744 can have a filter length 960 of between approximately nine inches and 14 inches. In one such embodiment, the filter body 744 can have a filter length 960 of approximately 11.5 inches. Alternatively, in other embodiments, the filter body 744 can have a filter length 960 of greater than 14 inches or less than nine inches.

Based on the design of the filter assembly 720 in this embodiment, it is appreciated that a mount length of the filter connector 742 would be substantially the same as the filter length 960 of the filter body 744.

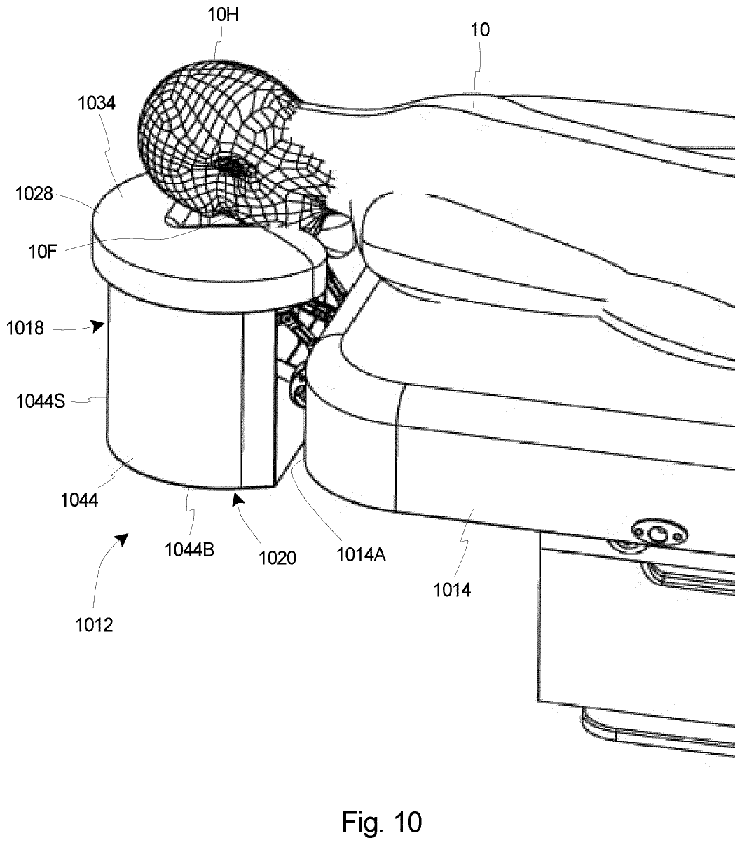

FIG. 10 is a simplified perspective view of a user 10 and a portion of yet another embodiment of the treatment device assembly 1012 including a headrest assembly 1018 having yet another embodiment of the filter assembly 1020 incorporated therein. As above, the treatment device assembly 1012 includes a treatment device 1014 and the headrest assembly 1018, including the headrest 1028 and the filter assembly 1020, that is selectively coupled to the treatment device 1014, e.g., to an end 1014A of the treatment device 1014. Additionally, as above, the headrest assembly 1018 is configured to support the head 10H and/or face 10F of the user 10 when the user is positioned on the treatment device assembly 1012. Further, as shown, the filter assembly 1020 is integrated and/or incorporated within the headrest assembly 1018 such that the filter assembly 1020 extends in a generally downward direction from the headrest 1028 to provide a physical (filtered) barrier between the face 10F of the user 10 and a treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

The treatment device 1014 is substantially similar in design and function to the embodiments illustrated and described herein above. Accordingly, the treatment device 1014 will not be described in detail again herein.

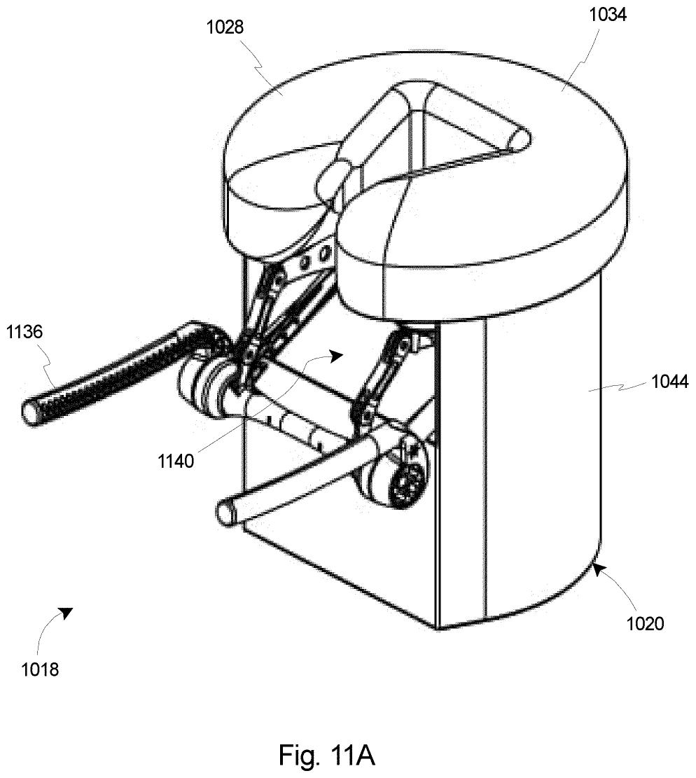

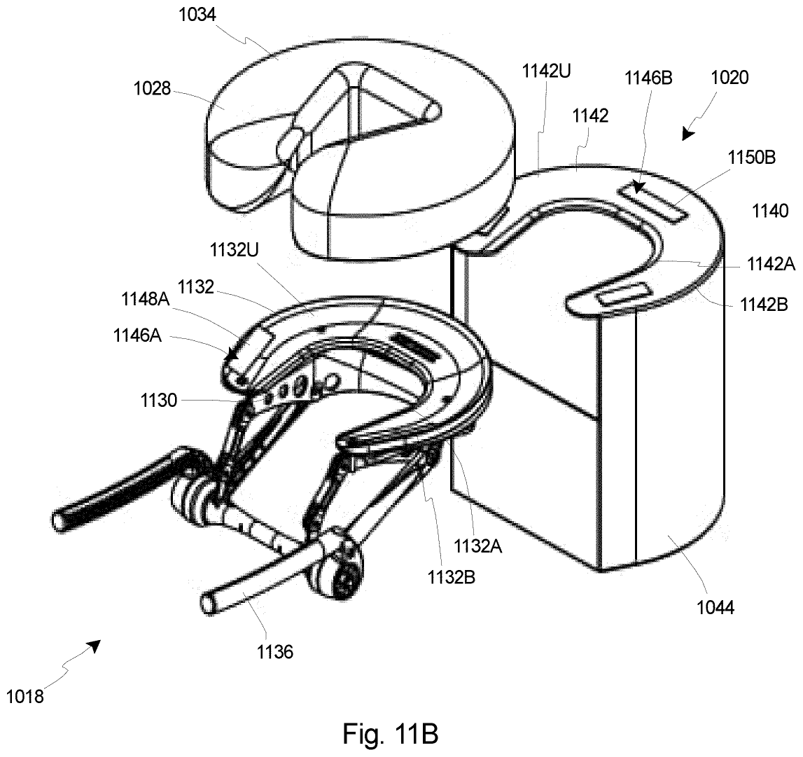

Additionally, the headrest 1028 is also substantially similar in design and function to the embodiments illustrated and described herein above. For example, the headrest 1028 again includes a headrest support frame 1130 (illustrated in FIG. 11B), a headrest platform 1132 (illustrated in FIG. 11B), a headrest cushion 1034, and headrest support arms 1136 (illustrated in FIG. 11A) that are substantially similar to the corresponding components illustrated and described herein above. Accordingly, the components of the headrest 1028 will not be described in detail again herein.

Further, the filter assembly 1020 is somewhat similar to the previous embodiments. For example, the filter assembly 1020 again includes a filter connector 1142 (illustrated in FIG. 11B) and the filter body 1044 that are somewhat similar in general design and function to the previous embodiments. However, as illustrated, the filter assembly 1020 is somewhat different than the embodiment illustrated and described herein above. In particular, as described in greater detail herein below, in the embodiment illustrated in FIG. 10, the filter assembly 1020 is again configured to be selectively coupled to the headrest platform 1132. More specifically, the filter assembly 1020 includes the filter connector 1142 that is mounted substantially directly on top of and selectively coupled to the headrest platform 1132. With such design, when the headrest assembly 1018 is fully assembled, the filter connector 1142 is positioned substantially between the headrest platform 1132 and the headrest cushion 1034. Additionally, in this embodiment, the filter body 1044 is configured and/or positioned to substantially surround the headrest platform 1132 and much of the remainder of the headrest 1028 that is positioned below the headrest platform 1132. Stated in another manner, a substantial portion of the headrest 1028, including the headrest platform 1132 and below, is positioned within the filtering cavity 1140 (illustrated in FIG. 11A) that is defined at least in part by the filter connector 1142 and the filter body 1044, i.e. the base 1044B and the sides 1044S of the filter body 1044. It is appreciated that much of the headrest 1028 is not visible in FIG. 10 as being positioned within the filtering cavity 1140.

FIG. 11A is a simplified perspective view of the headrest assembly 1018 including the embodiment of the filter assembly 1020 illustrated in FIG. 10. Additionally, FIG. 11B is a partially exploded view of the headrest assembly 1018 illustrated in FIG. 11A. As illustrated in FIGS. 11A and 11B, in this embodiment, the headrest assembly 1018 includes the headrest 1028 having the headrest support frame 1130, the headrest platform 1132, the headrest cushion 1034, and the headrest support arms 1136; and the filter assembly 1020 that is coupled to the headrest 1028 so as to be integrated and/or incorporated into the headrest assembly 1018.

As noted above, in this embodiment, the filter assembly 1020 again includes the filter connector 1142, and the filter body 1044 that is coupled to and/or integrally formed with the filter connector 1142 and that extends generally downward from the filter connector 1142. Additionally, the filter assembly 1020 and/or the filter body 1044 again defines at least a portion of the filtering cavity 1140, i.e. formed inside the sides 1044S and the base 1044B of the filter body 1044, that is configured to be positioned substantially directly beneath the head 10H (illustrated in FIG. 10) and/or face 10F (illustrated in FIG. 10) of the user 10 (illustrated in FIG. 10) when the user 10 is positioned on and/or supported by the treatment device 1014 (illustrated in FIG. 10) and/or the headrest assembly 1018. As provided herein, the inclusion of the filtering cavity 1140 as defined at least in part by the filter assembly 1020 and/or the filter body 1044 again enables advantages such as providing a physical (filtered) barrier between the face 10F of the user 10 and the treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

As further noted above, in this embodiment, the filter connector 1142 is mounted substantially directly on top of and selectively coupled to the headrest platform 1132, so as to be positioned substantially between the headrest platform 1132 and the headrest cushion 1034 of the headrest 1028. Alternatively, in other embodiments, the filter connector 1142 can be selectively coupled to the headrest 1028 in another suitable manner.

The filter connector 1142 can be removably coupled to the headrest platform 1132 and/or the headrest cushion 1034 in any suitable manner. In certain embodiments, the filter connector 1142 can be removably coupled to the headrest platform 1132 with a first coupling assembly 1146A; and/or the filter connector 1142 can be removably coupled to the headrest cushion 1034 with a second coupling assembly 1146B. It is appreciated that the coupling assemblies 1146A, 1146B can have any suitable design for purposes of removably coupling the filter connector 1142 to the headrest platform 1132, and removably coupling the filter connector 1142 to the headrest cushion 1034.

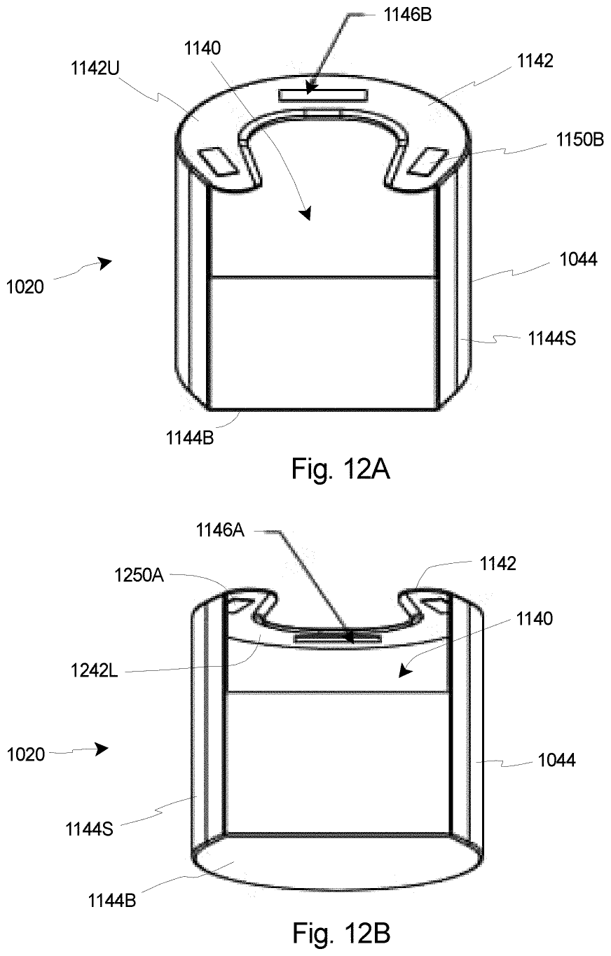

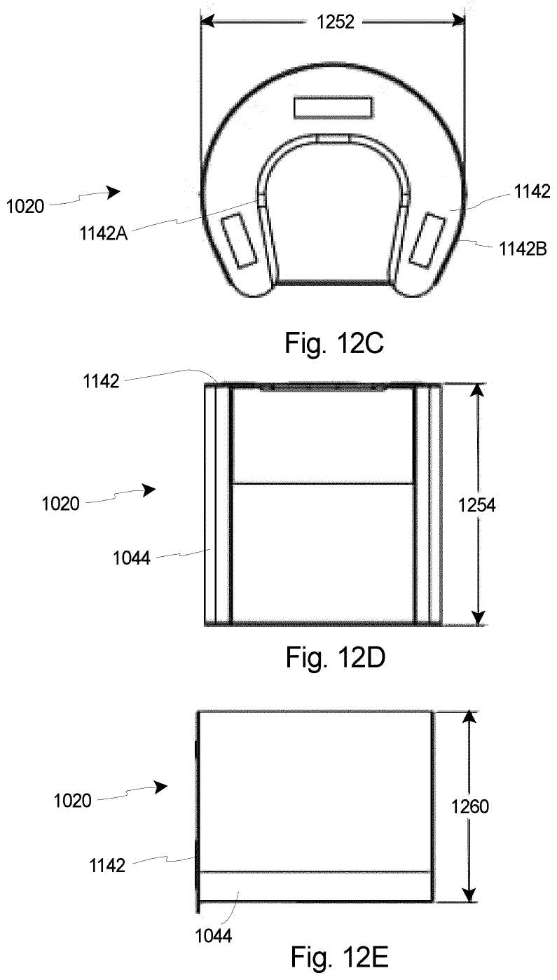

In one embodiment, the first coupling assembly 1146A includes one or more first coupling members 1148A that are secured to an upper surface 1132U of the headrest platform 1132, and one or more second coupling members 1250A (illustrated in FIG. 12B) that are secured to a lower surface 1242L (illustrated in FIG. 12B) of the filter connector 1142. In such embodiment, each of the one or more first coupling members 1148A is configured and/or positioned to engage one of the second coupling members 1250A during the selective coupling between the filter assembly 1020, i.e. the filter connector 1142, and the headrest platform 1132. In one such embodiment, each of the one or more first coupling members 1148A can be a piece of hook-and-loop material, and each of the one or more second coupling members 1250A can also be a piece of hook-and-loop material that is configured and/or positioned to engage one of the first coupling members 1148A during the selective coupling between the filter assembly 1020, i.e. the filter connector 1142, and the headrest platform 1132. Alternatively, the first coupling assembly 1146A, the one or more first coupling members 1148A and/or the one or more second coupling members 1250A can have another suitable design.

Similarly, in one embodiment, the second coupling assembly 1146B includes one or more first coupling members (not shown) that are secured to a lower surface of the headrest cushion 1034, and one or more second coupling members 1150B that are secured to an upper surface 1142U the filter connector 1142. In such embodiment, each of the one or more first coupling members is configured and/or positioned to engage one of the second coupling members 1150B during the selective coupling between the filter assembly 1020, i.e. the filter connector 1142, and the headrest cushion 1034. In one such embodiment, each of the one or more first coupling members can be a piece of hook-and-loop material, and each of the one or more second coupling members 11506 can also be a piece of hook-and-loop material that is configured and/or positioned to engage one of the first coupling members during the selective coupling between the filter assembly 1020, i.e. the filter connector 1142, and the headrest cushion 1034. Alternatively, the second coupling assembly 1146B, the one or more first coupling members and/or the one or more second coupling members 11506 can have another suitable design.

It is appreciated that the use of the terms “first coupling members” and “second coupling members” is merely for purposes of simplicity and ease of illustration, and either set of coupling members can be referred to as the “first coupling members” and/or the “second coupling members”. Additionally, it is further appreciated that the terms “first coupling assembly” and “second coupling assembly” is merely for purposes of simplicity and ease of illustration, and either coupling assembly 1146A, 1146B can be referred to as the “first coupling assembly” and/or the “second coupling assembly”.

Additionally, similar to the previous embodiments, the filter connector 1142 can again be substantially horseshoe-shaped, in this instance to match the size and shape of the substantially horseshoe-shaped headrest platform 1132 and/or the substantially horseshoe-shaped headrest cushion 1034. More particularly, with such design, the filter connector 1142 includes an inner edge 1142A and an outer edge 1142B that correspond with an inner edge 1132A and an outer edge 1132B of the headrest platform 1132.

The filter connector 1142 can be formed from any suitable materials. For example, in certain embodiments, the filter connector 1142 can be formed from one or more of leather, plastic, cloth (e.g., cotton and/or microfiber), or other suitable materials. Alternatively, in other embodiments, the filter connector 1142 can be formed from one or more of wood, aluminum, steel or other suitable rigid materials.

In this embodiment, the filter body 1044 extends in a generally downward direction from the outer edge 11426 of the filter connector 1142 (and, thus, the filter body 1044 also extends in a generally downward direction from the outer edge 11326 of the headrest platform 1132). Further, as noted above, the filter body 1044 can be formed from any suitable materials. For example, in certain embodiments, the filter body 1044 can be formed from one or more materials, such as cotton and/or microfiber, that are specifically configured to filter the respiratory droplets and/or aerosols from the user 10. Alternatively, the filter body 1044 can be formed from other suitable filtering materials. For example, in some other non-exclusive alternative embodiments, the filter body 1044 can be formed from one or more of synthetic plastic fibers such as polypropylene and polyester.

The filter connector 1142 and the filter body 1044 can have any suitable size and shape, certain embodiments (i.e. dimensions) of which will be described in greater detail herein below in relation to FIGS. 12A-12E.

FIG. 12A is a simplified top perspective view of the filter assembly 1020 illustrated in FIG. 11A. In particular, FIG. 12A illustrates a top perspective view of the filter assembly 1020 including the filter connector 1142, and the filter body 1044. Additionally, FIG. 12A further illustrates the filtering cavity 1140 that is defined at least in part by the base 1144B and sides 1144S of the filter body 1044.

Additionally, FIG. 12A also shows a portion of the second coupling assembly 1146B. More particularly, FIG. 12A illustrates the one or more second coupling members 1150B, e.g., hook-and-loop material in one embodiment, that are secured to the upper surface 1142U of the filter connector 1142, and that are configured to selectively engage the one or more first coupling members that are secured to a lower surface of the headrest cushion 1034 (illustrated in FIG. 10).

FIG. 12B is a simplified bottom perspective view of the filter assembly 1020 illustrated in FIG. 12A. In particular, FIG. 12B illustrates a bottom perspective view of the filter assembly 1020 including the filter connector 1142, and the filter body 1044. FIG. 12B again also illustrates the filtering cavity 1140 that is defined at least in part by the base 1144B and sides 1144S of the filter body 1044.

Additionally, FIG. 12B further illustrates a portion of the first coupling assembly 1146A. More particularly, FIG. 12B illustrates the one or more second coupling members 1250A, e.g., hook-and-loop material in one embodiment, that are secured to the lower surface 1242L of the filter connector 1142, and that are configured to selectively engage the one or more first coupling members 1148A (illustrated in FIG. 11B) that are secured to the upper surface 1132U (illustrated in FIG. 11B) of the headrest platform 1132.

FIGS. 12C-12E are simplified alternative views of the filter assembly 1020 illustrated in FIG. 12A, which illustrate certain potential dimensions of the components of the filter assembly 1020. More specifically, FIG. 12C is a simplified top view of the filter assembly 1020 illustrated in FIG. 12A; FIG. 12D is a simplified front view of the filter assembly 1020 illustrated in FIG. 12A; and FIG. 12E is a simplified side view of the filter assembly 1020 illustrated in FIG. 12A.

In FIG. 12C, a mount width 1252 of the filter connector 1142 is illustrated. In certain non-exclusive embodiments, the filter connector 1142 can have a mount width 1252 of between approximately seven inches and 13 inches. In one such embodiment, the filter connector 1142 has a mount width 1252 of approximately 10.2 inches. Alternatively, in other embodiments, the filter connector 1142 can have a mount width 1252 of greater than 13 inches or less than seven inches.

Additionally, FIG. 12C also clearly illustrates the inner edge 1142A and the outer edge 1142B of the filter connector 1142.

FIG. 12D illustrates the filter connector 1142 and a filter height 1254 of the filter body 1044 of the filter assembly 1020 as it extends generally downwardly away from the filter connector 1142. In certain non-exclusive embodiments, the filter body 1044 can have a filter height 1254 of between approximately 7.5 inches and 13 inches. In one such embodiment, the filter body 1044 can have a filter height 1254 of approximately 10.2 inches. Alternatively, in other embodiments, the filter body 1044 can have a filter height 1254 of greater than 13 inches or less than 7.5 inches.

FIG. 12E illustrates a filter length 1260 of the filter body 1044. In certain non-exclusive embodiments, the filter body 1044 can have a filter length 1260 of between approximately seven inches and ten inches. In one such embodiment, the filter body 1044 can have a filter length 1260 of approximately 8.6 inches. Alternatively, in other embodiments, the filter body 1044 can have a filter length 1260 of greater than ten inches or less than seven inches.

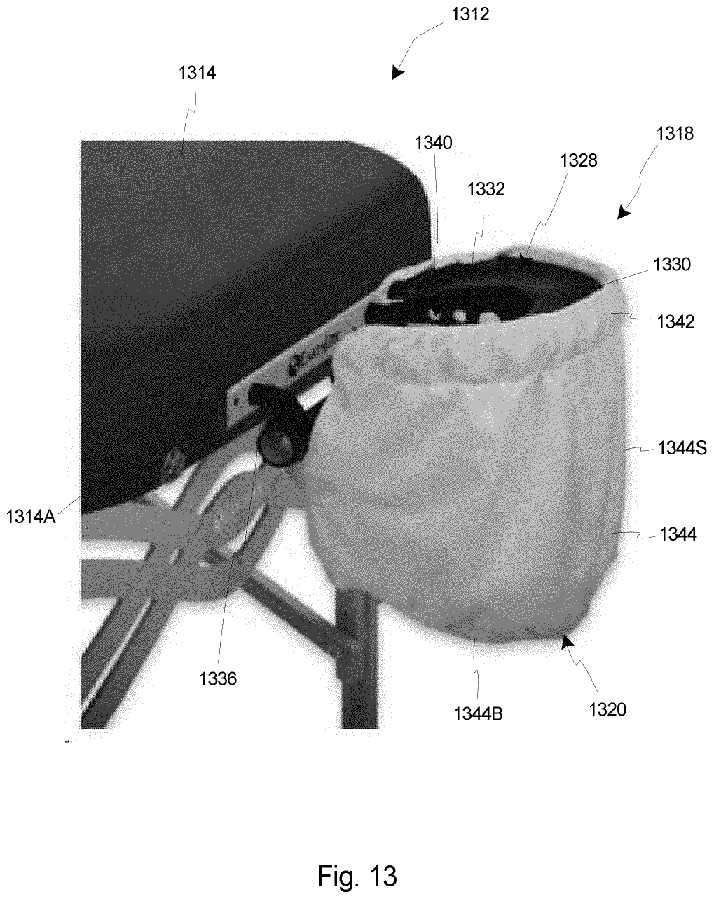

FIG. 13 is a simplified perspective view of a portion of still yet another embodiment of the treatment device assembly 1312 including a headrest assembly 1318 (without the headrest cushion shown) having still yet another embodiment of the filter assembly 1320 incorporated therein. As above, the treatment device assembly 1312 includes a treatment device 1314 and the headrest assembly 1318, including the headrest 1328 and the filter assembly 1320 that is coupled thereto and/or integrated therein, that is selectively coupled to the treatment device 1314, such as to an end 1314A of the treatment device 1314. Additionally, as above, the headrest assembly 1318 is configured to support the head 10H (illustrated in FIG. 1) and/or face 10F (illustrated in FIG. 1) of the user 10 (illustrated in FIG. 1) when the user 10 is positioned on the treatment device assembly 1312. Further, as shown, the filter assembly 1320 is integrated and/or incorporated within the headrest assembly 1318 such that the filter assembly 1320 extends in a generally downward direction from the headrest 1328 to provide a physical (filtered) barrier between the face 10F of the user 10 and a treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment.

The treatment device 1314 is substantially similar in design and function to the embodiments illustrated and described herein above. Accordingly, the treatment device 1314 will not be described in detail again herein.

Additionally, the headrest 1328 is also substantially similar in design and function to the embodiments illustrated and described herein above. For example, the headrest 1328 again includes a headrest support frame 1330, a headrest platform 1332, a headrest cushion (not shown in FIG. 13 for purposes of clarity), and headrest support arms 1336 that are substantially similar to the corresponding components illustrated and described herein above. Accordingly, the components of the headrest 1328 will not be described in detail again herein.

Further, the filter assembly 1320 is somewhat similar to the previous embodiments. For example, the filter assembly 1320 again includes a filter body 1344 that is somewhat similar in general design and function to the previous embodiments. Additionally, the filter assembly 1320 again also includes a filter connector 1342 that is coupled to and/or integrally formed with the filter body 1344 and that is configured to connect the filter assembly 1320 to the headrest 1328.

However, in this embodiment, the filter connector 1342 has a different design that those illustrated and described in the previous embodiments. More particularly, in the embodiment illustrated in FIG. 13, the filter connector 1342 is formed at least in part from and/or includes an elastic material that is provided in the form of an elastic strap or band that is coupled to the filter body 1344, and that is configured to be positioned around at least a portion of the headrest 1328, such as the headrest platform 1332 or the headrest cushion. In one embodiment, as shown, the filter connector 1342 can be selectively coupled to the headrest platform 1342 by stretching the elastic band of the filter connector 1342 so that it extends around at least a portion of the headrest platform 1342. Upon relaxing the stretch of the elastic band of the filter connector 1342, the filter connector 1342 can then fit snugly about at least a portion of the headrest platform 1332. With such design, when the headrest assembly 1318 is fully assembled, the filter connector 1342 is positioned at least partially between the headrest platform 1332 and the headrest cushion. Alternatively, in another embodiment, the filter connector 1342 can be similarly selectively coupled to the headrest cushion by stretching the elastic band of the filter connector 1342 so that it extends around at least a portion of the headrest cushion.

Additionally, in this embodiment, the filter body 1344 is configured and/or positioned to substantially surround at least a portion of the headrest platform 1332 and much of the remainder of the headrest 1328 that is positioned below the headrest platform 1332. Stated in another manner, a substantial portion of the headrest 1328, including the headrest platform 1332 and below, can be positioned within the filtering cavity 1340 that is defined at least in part by the filter connector 1342 and the filter body 1344, i.e. the base 1344B and the sides 1344S of the filter body 1344.

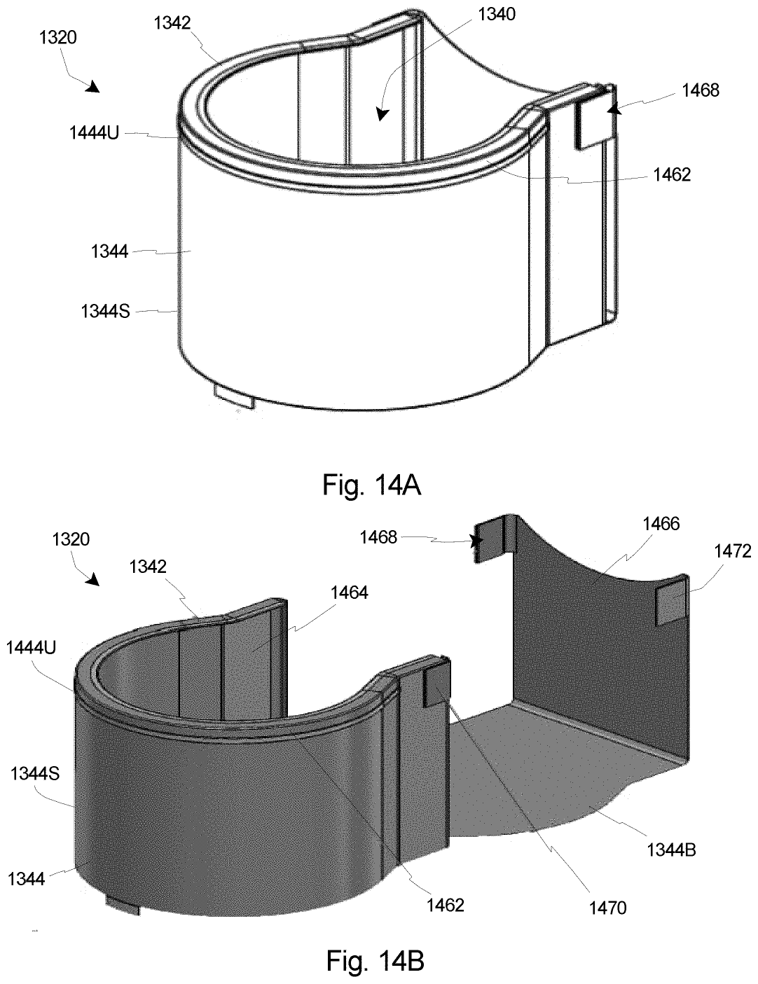

FIGS. 14A and 14B are simplified alternative views of the filter assembly 1320 illustrated in FIG. 13, which more clearly illustrate various features of the filter assembly 1320. More particularly, FIG. 14A is a simplified top perspective view of the filter assembly 1320 illustrated in FIG. 13; and FIG. 14B is a partially exploded perspective view of the filter assembly 1320 illustrated in FIG. 14A.

As illustrated in FIGS. 14A and 14B, in this embodiment, the filter assembly 1320 again includes the filter connector 1342, and the filter body 1344 that is coupled to and/or integrally formed with the filter connector 1342 and that extends generally downward from the filter connector 1342. Additionally, the filter assembly 1320 and/or the filter body 1344 again defines at least a portion of the filtering cavity 1340 (shown in FIG. 14A), i.e. formed inside the sides 1344S and the base 1344B (illustrated more clearly in FIG. 14B) of the filter body 1344, that is configured to be positioned substantially directly beneath the head 10H (illustrated in FIG. 1) and/or face 10F (illustrated in FIG. 1) of the user 10 (illustrated in FIG. 1) when the user 10 is positioned on and/or supported by the treatment device 1314 (illustrated in FIG. 13) and/or the headrest assembly 1318 (illustrated in FIG. 13). As provided herein, the inclusion of the filtering cavity 1340 as defined at least in part by the filter assembly 1320 and/or the filter body 1344 again enables advantages such as providing a physical (filtered) barrier between the face 10F of the user 10 and the treatment provider to trap respiratory particulates and to inhibit and/or filter the dispersal or spread of respiratory droplets and potentially viral respiratory aerosols between the user 10 and the treatment provider so that the user 10 does not need to wear a mask while receiving the therapeutic treatment. In certain implementations, the filter assembly 1320 provides the barrier and is held in place without engaging (contacting) the user 10.

The filter connector 1342 can be removably coupled to the headrest 1328 (illustrated in FIG. 13) in any suitable manner. As described above, in this embodiment, the filter connector 1342 includes elastic material that is provided in the form of one or more elastic straps or bands that are configured to be stretched such that they can be positioned substantially about at least a portion of the headrest platform 1332 (illustrated in FIG. 13). With such design, at least a portion of the filter connector 1342 can be positioned substantially between the headrest platform 1332 and the headrest cushion of the headrest 1328 (illustrated in FIG. 13). Alternatively, in other embodiments, the filter connector 1342 can be selectively coupled to the headrest 1328 in another suitable manner.

The filter connector 1342 can be coupled to and/or integrally formed with the filter body 1344 in any suitable manner. For example, in certain embodiments, an upper edge 1444U of the filter body 1344 can be folded over to form a connector pocket 1462, and the filter connector 1342 can be positioned substantially within the connector pocket 1462. In one such embodiment, the connector pocket 1462 can be formed by folding over the upper edge 1444U of the filter body 1344 and sewing the folded material to the remainder of the filter body 1344 (or fixedly securing it in another suitable manner) to thus form the connector pocket 1462 therein. It is appreciated that in such embodiment, the filter connector 1342 would be positioned within the connector pocket 1462 prior to the folded material at the upper edge 1444U of the filter body 1344 being fixedly secured to the remainder of the filter body 1344. Alternatively, the filter connector 1342 can be coupled to and/or integrally formed with the filter body 1344 in another suitable manner.

Additionally, similar to the previous embodiments, when coupled to the headrest 1328, the filter connector 1342 can again be substantially horseshoe-shaped.

In this embodiment, the filter body 1344 again extends in a generally downward direction from filter connector 1342. As shown in FIG. 14B, in certain embodiments, the filter body 1344 can be formed from multiple pieces of material, such as cotton and/or microfiber in certain non-exclusive embodiments or other suitable materials. In particular, as shown in this embodiment, the filter body 1344 can be formed from two pieces of material, i.e. a first body member 1464 and a second body member 1466. In one embodiment, the first body member 1464 can encompass at least a majority of the sides 1344S of the filter body 1344; and the second body member 1466 can encompass the base 1344B of the filter body 1344 as well as at least a portion of the sides 1344S of the filter body 1344. Alternatively, the filter body can be formed from more than two pieces of material and/or the body members 1464, 1466 can encompass different portions of the filter body 1344 than what is specifically shown in FIG. 14B. Still alternatively, in other embodiments, the filter body 1344 can be formed from a single piece of material.

In some embodiments, the first body member 1464 and the second body member 1466 can be fixedly secured to one another. For example, in one embodiment, the first body member 1464 and the second body member 1466 can be fixedly secured to one another by sewing (or otherwise fixedly securing) the base 1344B of the filter body 1344 that is formed into the second body member 1466 to a lower edge of the sides 1344S of the filter body 1344 that are formed into the first body member 1464.

Additionally, as shown, the portion of the second body member 1466 that forms a portion of the sides 1344S of the filter body 1344 can be selectively coupled to the first body member 1464 with a member coupling assembly 1468. In one embodiment, the member coupling assembly 1468 includes one or more first coupling members 1470 that are secured to the first body member 1464 substantially adjacent to the upper edge 1444U of the filter body 1344, and one or more second coupling members 1472 that are secured to the second body member 1466 near an upper edge of the second body member 1466 that is configured to form a portion of the sides 1344S of the filter body 1344. In such embodiment, each of the one or more first coupling members 1470 is configured and/or positioned to engage one of the second coupling members 1470 during the selective coupling between the portion of the second body member 1466 that forms a part of the sides 1344S of the filter body 1344 and the first body member 1464. In one such embodiment, each of the one or more first coupling members 1470 can be a piece of hook-and-loop material, and each of the one or more second coupling members 1472 can also be a piece of hook-and-loop material that is configured and/or positioned to engage one of the first coupling members 1470 during the selective coupling between the noted portions of the body members 1464, 1466. With such design, the temporary, selective coupling between such portions of the first body member 1464 and the second body member 1466 enables the filter assembly 1320 to be more effectively coupled to the headrest 1328 while allowing necessary space for the components of the headrest 1328, such as the headrest support arms 1336 (illustrated in FIG. 13). Alternatively, the member coupling assembly 1468, the one or more first coupling members 1470 and/or the one or more second coupling members 1472 can have another suitable design.

It is appreciated that the use of the terms “first body member” and “second body member” is merely for purposes of simplicity and ease of illustration, and either body member can be referred to as the “first body member” and/or the “second body member”. Additionally, it is further appreciated that the use of the terms “first coupling members” and “second coupling members” is merely for purposes of simplicity and ease of illustration, and either set of coupling members can be referred to as the “first coupling members” and/or the “second coupling members”.

Similar to previous embodiments, the filter body 1344 can again be formed from any suitable materials. For example, in certain embodiments, the filter body 1344 can be formed from one or more materials, such as cotton and/or microfiber, that are specifically configured to filter the respiratory droplets and/or aerosols from the user 10 (illustrated in FIG. 1). Alternatively, the filter body 1344 can be formed from other suitable filtering materials. For example, in some other non-exclusive alternative embodiments, the filter body 1344 can be formed from one or more of synthetic plastic fibers such as polypropylene and polyester.

It is appreciated that in various embodiments, the filter connector 1342 and the filter body 1344 can have any suitable size, shape, and dimensions to provide the filtering cavity 1340 of suitable and/or desired size.

It is understood that although a number of different embodiments of the treatment device assembly 12, the headrest assembly 18, and/or the filter assembly 20 have been illustrated and described herein, one or more features of any one embodiment can be combined with one or more features of one or more of the other embodiments, provided that such combination satisfies the intent of the present invention.

While a number of exemplary aspects and embodiments of the treatment device assembly 12, the headrest assembly 18, and/or the filter assembly 20 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A headrest assembly for supporting a head or face of a user of a treatment device, the headrest assembly comprising:
a headrest that is configured to support the head or face of the user; and
a filter assembly that is coupled to the headrest.

2. The headrest assembly of claim 1 wherein the filter assembly includes a filter connector that is selectively coupled to the headrest, and a filter body that extends in a generally downward direction away from the filter connector.

3. The headrest assembly of claim 2 wherein the filter connector includes an inner edge; and wherein the filter body extends in a generally downward direction away from the inner edge of the filter connector.

4. The headrest assembly of claim 2 wherein the filter connector includes an outer edge; and wherein the filter body extends in a generally downward direction away from the outer edge of the filter connector.

5. The headrest assembly of claim 2 wherein the filter connector includes an elastic strap.

6. The headrest assembly of claim 2 wherein the filter body is integrally formed with the filter connector.

7. The headrest assembly of claim 2 wherein the filter body is coupled to the filter connector.

8. The headrest assembly of claim 2 wherein the filter body includes sides and a base that cooperate to define at least a portion of a filtering cavity that is configured to be positioned substantially directly below the head or face of the user when the head or face of the user is supported by the headrest.

9. The headrest assembly of claim 2 wherein the filter body is formed from at least one of a cotton material and a microfiber material.

10. The headrest assembly of claim 2 wherein the headrest includes a headrest cushion and a headrest platform that is configured to support the headrest cushion; and wherein the filter connector is coupled to an upper surface of the headrest platform such that the filter connector is positioned substantially between the headrest platform and the headrest cushion.

11. The headrest assembly of claim 2 wherein the headrest includes a headrest cushion and a headrest platform that is configured to support the headrest cushion; and wherein the filter connector is coupled to an upper surface of the headrest cushion.

12. A treatment device assembly including a treatment device that supports the user during a therapeutic treatment, and the headrest assembly of claim 1 that is selectively coupled to the treatment device.

13. A method for supporting a head of a user of a treatment device, the method comprising the steps of:
supporting the head or face of the user with a headrest; and
coupling a filter assembly to the headrest.

14. The method of claim 13 wherein the step of coupling includes the filter assembly including a filter connector and a filter body, and further includes selectively coupling the filter connector to the headrest, and extending the filter body in a generally downward direction away from the filter connector.

15. The method of claim 14 wherein the step of coupling further includes the filter connector including an inner edge; and wherein the step of extending includes extending the filter body in a generally downward direction away from the inner edge of the filter connector.

16. The method of claim 14 wherein the step of coupling further includes the filter connector including an outer edge, and wherein the step of extending includes extending the filter body in a generally downward direction away from the outer edge of the filter connector.

17. The method of claim 14 wherein the step of coupling further includes the filter connector including an elastic strap.

18. The method of claim 14 wherein the step of coupling includes the filter body being integrally formed with the filter connector.

19. The method of claim 14 wherein the step of coupling includes the filter body being coupled to the filter connector.

20. The method of claim 14 wherein the step of extending includes the filter body including sides and a base that cooperate to define at least a portion of a filtering cavity that is configured to be positioned substantially directly below the head or face of the user when the head or face of the user is supported by the headrest.

21. The method of claim 14 wherein the step of extending includes the filter body being formed from at least one of a cotton material and a microfiber material.

22. The method of claim 14 wherein the step of supporting includes the headrest including a headrest cushion and a headrest platform that is configured to support the headrest cushion; and wherein the step of coupling includes coupling the filter connector to an upper surface of the headrest platform such that the filter connector is positioned substantially between the headrest platform and the headrest cushion.

23. The method of claim 14 wherein the step of supporting includes the headrest including a headrest cushion and a headrest platform that is configured to support the headrest cushion; and wherein the step of coupling includes coupling the filter connector to an upper surface of the headrest cushion.
